(19) United States
(12) Patent Application Publication
(10) Pub. No.: US 2023/0228085 A1
(43) Pub. Date: Jul. 20, 2023

(54) FABRIC REINFORCEMENT FOR IMPROVING CEMENT BOARD FLEXURAL STRENGTH AND METHODS FOR MAKING SAME

(71) Applicant: UNITED STATES GYPSUM COMPANY, Chicatgo, IL (US)

(72) Inventors: David R. Blackburn, Grayslake, IL (US); Jeffrey W. Donelan, Libertyville, IL (US); Ashish Dubey, Grayslake, IL (US); Christopher B. Tesmer, McHenry, IL (US); James B. O'Sullivan, Bartlett, IL (US)

(21) Appl. No.: 17/937,115

(22) Filed: Sep. 30, 2022

Related U.S. Application Data
(60) Provisional application No. 63/299,708, filed on Jan. 14, 2022.

(51) Int. Cl. E04C 5/07; E04C 2/06; B28B 23/00; D03D 13/00; D03D 15/267

(52) U.S. Cl. CPC E04C 5/073; E04C 2/06; B28B 23/0006; D03D 13/008; D03D 15/267; D10B 2505/02; D10B 2401/063

(57) ABSTRACT

Fabric reinforcement for reinforcing alkaline cementitious matrix including warp yarns and weft yarns. To increase cohesive tensile strength of intersection points of the fabric the fabric has sufficient resinous coating over a substantial portion of the warp and weft yarns, before the fabric reinforcement is embedded within, or adhesively or mechanically bonded to the cementitious matrix, wherein the coating includes organic or inorganic adhesives/polymers, or the fabric has uncoated fabric modified by adhering fabric strands together where machine direction and cross-machine strands intersect, for example with cyanoacrylate or epoxy. Bond strength of the intersecting yarns of the fabric and the corresponding mechanical bond strength of the fabric to the cementitious matrix may also be enhanced by increasing roughness and/or surface area of the yarns and resulting fabric. Methods for making fabric, cementitious boards employing the fabric, and methods for making the cementitious board are also provided.

### FIELD OF THE INVENTION

The present invention relates generally to cementitious panels or boards, including cement board and cement fiberboard, wherein the cementitious board is reinforced for tensile strength and impact resistance through use of an improved fabric reinforcement. This invention also relates to coated reinforcing fabrics, and more particularly to alkali-resistant fabric reinforcements for cementitious materials.

### BACKGROUND OF THE INVENTION

The use of reinforced cement panels is well known in industries such as cementitious backerboards used in the ceramic tile industry. Generally, cement panels or boards contain a core formed of a cementitious material which may be interposed between two layers of facing material. The facing materials employed typically share the features of high strength, high modulus of elasticity, and light weight to contribute flexural and impact strength to the high compressive strength, but brittle material forming the cementitious core. Typically, the facing material employed with cement panels is fiberglass fibers or fiberglass mesh embedded in the cementitious slurry core. Cementitious boards useful in the construction industry are known to contain inorganic, hydraulically setting material, such as Portland cement or gypsum. Hydraulic gypsum and cement, once set, have very little tensile strength and are usually reinforced with facing materials which improve the resistance to tensile and flexural loads. This has been the basis for using paper facing on conventional gypsum wall board and glass fiber scrim in cement boards.

Cementitious backerboard comprises a panel having a core layer of light-weight concrete with each of the two faces covered with a layer of reinforcing fabric bonded to the core layer. Such cementitious backerboards are described in U.S. Pat. No. 3,284,980 P. E. Dinkel, incorporated herein by reference in its entirety. These panels are nailable and can be readily fastened to the framing members. Furthermore they are substantially unaffected by water and consequently find extensive use in wet areas such as shower enclosures, bathtub surrounds, kitchen areas and entryways, as well as on building exteriors.

The facing material is typically a mesh or scrim reinforcing fabric having a yarn count per 2.54 centimeter (1 inch) of the reinforcing fabric that varies from 8×4 to 12×20, for example 8×8 to 12×20, depending upon the size of the openings in the mesh or scrim for passage of the bonding material through the fabric. Other pervious fabrics having suitable tensile strength, alkali resistance and sufficiently large pores or openings may be employed.

Commonly the reinforcing fabric is bonded to the surface of the core layer with a thin coating of Portland cement slurry, with or without some fine aggregate added. Alternatively, the core mix can be sufficiently fluid to be vibrated or forced through the openings of the reinforcing fabric to cover the fabric and to bond it to the core layer. This is described in U.S. Pat. No. 4,450,022 of Galer, the disclosure of which is incorporated herein by reference in its entirety.

Cementitious boards have been manufactured by casting a hydraulic cement core mixt in the form of a thin, indefinitely long panel. Cementitious boards are generally produced using a core mix of water, light-weight aggregate (e.g., expanded clay, expanded slag, expanded shale, perlite, expanded glass beads, polystyrene beads, and the like) and a cementitious material (e.g., Portland cement, magnesia cement, alumina cement, gypsum and blends of such materials). A foaming agent as well as other additives can be added to the mix. The hydraulic cement core mix is usually a mortar containing a mixture of water and Portland cement, sand, mineral or non-mineral aggregate, fly ash, accelerators, plasticizers, foaming agents and/or other additives. A strippable paper is deposited on a forming table, then a scrim fed from a roll is deposited on the strippable paper, then a continuous stream of mortar slurry is deposited onto the scrim. The mortar is then distributed across the breadth of the carrier sheet, and the mortar-laden carrier sheet is towed through a slit defined by a supporting surface and a cylindrical mortar screeding roller mounted above the supporting surface so that its axis is transversely parallel to the supporting surface. The long network of reinforcing fibers is drawn against the roller and through the slit, rotating the roller counter to the direction of the travel of the carrier sheet, whereby the roller presses the network into the surface of the mortar and wipes mortar adhering to the roller into the interstices of the network. The network then tows the resulting broad, flat ribbon of mortar towards a cutter.

US Patent application publication number 2009/0011207, incorporated herein by reference, discloses a fast setting lightweight cementitious composition for construction of cement board or panels. The cementitious composition includes 35-60 wt. % cementitious reactive powder (also termed Portland cement-based binder), 2-10 wt. % expanded and chemically coated perlite filler, 20-40 wt. % water, entrained air, for example 10-50 vol. %, on a wet basis, entrained air, and optional additives such as water reducing agents, chemical set-accelerators, and chemical set-retarders. The lightweight cementitious compositions may also optionally contain 0-25 wt. % secondary fillers, for example 10-25 wt. % secondary fillers. Typical filler include one or more of expanded clay, shale aggregate, and pumice. The cementitious reactive powder used is typically composed of either pure Portland cement or a mixture of Portland cement and a suitable pozzolanic material such as fly ash or blast furnace slag. The cementitious reactive powder may also optionally contain one or more of gypsum (land plaster) and high alumina cement (HAC) added in small dosages to influence setting and hydration characteristics of the binder.

Other methods of manufacture of cement boards are disclosed in U.S. Pat. No. 4,203,788 to Clear incorporated herein by reference, which discloses a method and apparatus for producing fabric reinforced tile backerboard panel. U.S. Pat. No. 4,488,909 to Galer et al. incorporated herein by reference describes in further detail, in column 4, the cementitious composition used in a cementitious backerboard. U.S. Pat. No. 4,504,335 to Galer incorporated herein by reference discloses a modified method for producing fabric reinforced cementitious backerboard. U.S. Pat. No. 4,916,004 to Ensminger et al. incorporated herein by reference describes a reinforced cementitious panel in which the reinforcement wraps the edges and is embedded in the core mix.

The disclosures of all of the US Patents listed in the present specification are incorporated herein by reference in their entirety.

The reinforcing fabric most generally employed is a fiber glass scrim and, in particular, is a woven mesh of vinyl coated fiber glass yarns. Glass fiber meshes have been popular as a facing sheet in cement boards because they can increase the dimensional stability in the presence of moisture and provide greater physical and mechanical properties. However, Common cements, such as Portland cement, provide an alkaline environment when in contact with water, and the fiberglass yarn used in reinforcement fabrics is degraded in these highly alkaline conditions. Most glass fiber compositions, other than AR glass, degrade in the alkali environment of a cement core, so they must be coated with a protective finish.

U.S. Pat. No. 6,187,409 B1 to Mathieu, incorporated herein by reference discloses cementitious panel is reinforced with a fabric at its surface and the longitudinal edges are reinforced with a network of fibers. A continuous band of synthetic alkali-resistant, non-woven fabric completely covers the edge areas of the board with a U-shaped reinforcing mesh to make the edges resistant to impact.

US published application US2004/0219845 to Graham, incorporated herein by reference, proposed to use a carbon fiber fabric to form a scrim that wraps the board and its edges and is bonded to the board surface with an adhesive. Polyvinyl alcohol, acrylic, polyvinyl acetate, polyvinyl chloride, polyvinylidene chloride, polyacrylate, acrylic latex or styrene butadiene rubber, plastisol are disclosed as adhesives.

U.S. Pat No. 6,054,205 to Newman et al. and related U.S. Pat. No. 6,391,131 to Newman et al, both incorporated herein by reference, disclose glass fiber facing sheets comprising an open mesh glass scrim having a plurality of intersecting continuous multifilament yarns. The multifilament yarns are bonded at their crossover points to form a dimensionally stable scrim which can be used to make a cement board with facing sheets mechanically integrated into opposed surface portions of a cementitious core. A conventional method for making the glass fiber facing sheet and a method of making a cement board with this glass facing sheet is disclosed in the related U.S. Pat. No. 6,391,131 to Newman et al.

U.S. Pat. No. 7,045,474 to Cooper et al. proposed using composite fabric for reinforcement, particularly tensile reinforcement of cementitious boards. In particular it discloses mesh constructed from fabric of high modulus strands made from bundles of glass fibers encapsulated by alkali and water resistant thermoplastic material for embedment within the cement matrix to improve tensile strength and impact resistance of the cement board. The reinforcement fabric is disclosed as a woven knit, nonwoven or laid scrim open mesh fabric having mesh openings of a size suitable to permit interfacing between the skin and core cementitious matrix material. In a preferred construction, the fabric is in a grid-like configuration having a strand count of between about 2 to about 18 strands per inch in the length and width directions. The mesh is preferably composite yarns or rovings of an elastic core strands such as E-glass fibers or similar glass fibers sheathed in a continuous coating of water and alkali resistant material including, sheathed in material.

Woven knit and laid scrim fabrics may be coated either:
(a) before fabric-forming, as in single-end-coated fabrics;
(b) in-line (normally roller or dip coated) concurrently with formation such as in the case of laid scrim nonwoven meshes; or
(c) off-line coated after formation (normally roller or dip coated), typically used with many woven fabrics. In the case of coating before fabric-forming, the cost of coating each strand individually, in an operation prior to weaving, may be prohibitive. In the cases of in-line or off-line coating operations, the coating levels of the Machine Direction (MD) and Cross-Machine Direction (Known as CMD, XMD or CD) yarns are generally not independent.

A balanced coating weight distribution is desirable. It is easy to achieve in the case of single-end-coated (SEC) fabrics as each strand is independently and explicitly coated with a given level of coating. The coated strands are then combined into a fabric with the ratio of coating Dry Pick Up (DPU_{cd}/DPU_{md}) being established simply by selection of yarns containing the desired coating weights-often selected to be the same in MD and CD.

U.S. Pat. No. 7,354,876 and U.S. Pat. No. 7,615,504 to Porter et al. incorporated herein by reference propose to achieve balanced coating weight distribution for woven knit and laid scrim fabrics coated either in-line (normally roller or dip coated) or off-line coated after formation. The fabric and reinforcements are which, in a first embodiment, include a plurality of warp yarns having a first twist (turns/inch) and a plurality of weft yarns having a second twist which is greater than the first twist. A coating is applied over a substantial portion of the warp and weft yarns after they are assembled or laid together, so as to produce a weight distribution ratio of less than about 2.0:1, based upon the weight of the resinous coating of the weft yarns over the weight of the resinous coating on the warp yarns. This can be achieved, in substantial part, due to the difference in the twist ratios of the warp and weft yarns, which difference permits a more uniform coating to be applied. Further embodiments of Porter et al. include a cementitious board and methods of making a coated fabric and cementitious board.

Published application US 2012/0148806 to Dubey et al. discloses a cementitious board system which is reinforced on its opposed surfaces by an improved glass fiber scrim with thicker yarn and larger mesh openings to provide a cementitious board with improved handling properties while retaining tensile strength and long term durability. The fabric is constructed as a mesh of high modulus strands of bundled glass fibers encapsulated by alkali and water resistant material, e.g. a thermoplastic material. The composite fabric also has suitable physical characteristics for embedment within the cement matrix of the panels or boards closely adjacent the opposed faces thereof. The fabric provides a board system with long-lasting, high strength tensile reinforcement and improved handling properties regardless of their spatial orientation during handling.

There remains a need for an improved cementitious panel, e.g. a cement board reinforced with reinforcing fabric scrim or non-woven fabric layers which provides for more flexural strength and/or peak deflection.

### SUMMARY OF THE INVENTION

The present invention relates to a new and improved scrim (also known as fabric or mesh) useful in an alkaline matrix. The invention also provides a cementitious panel, such as cement board, reinforced with the scrim to have improved flexural strength and/or peak deflection. According to this invention, the bond strength of the intersecting yarns that are woven into a scrim is improved, which in turn improves the tensile and flexural strength of the associated cement board composite. The bond strength of the intersecting yarns of the scrim can be improved either chemically or mechanically or both. The resulting increase in bond strength of the intersecting yarns, in turn increases the bond of the scrim (both woven knit and laid scrim fabrics) to the alkaline cementitious matrix in which it is embedded. While not being limited to any particular theory, the inventors theorize that this improvement may increase flexural strength and/or peak deflection of associated cement board composites. Preferably, the woven knit and laid scrim fabrics of this invention comprise basalt fibers and/or glass fibers.

Increasing the chemical and/or mechanical bond of the scrim utilized in a scrim reinforced cementitious panel matrix can be achieved through many possible routes including but not limited to the following examples. Chemical bonding may be increased by applying organic or inorganic adhesives or polymers, such as epoxies, acrylics, styrene acrylics, sodium silicate, or other suitable coatings or bonding materials. Mechanical bonding may be altered by increasing the overall the roughness and/or surface area of the coated yarns of the reinforcing scrim. This may be achieved by embossing or roughening the coating surface, such as the surface of the PVC (polyvinyl chloride) coating commonly used in making the cement board scrims. Improved mechanical bond may also be achieved by bonding various fillers or fibers into or on the scrim coating (example, PVC coating) such as glass fiber, basalt fiber, alkaline resistant fiber, calcium carbonate, quartz, sand, fly ash, perlite, expanded aggregate or other similar materials. Additional weaves that increase surface area or add a third dimension such as a pile or velvet weave may improve mechanical bonding.

Chemical bonding may be increased by applying organic or inorganic adhesives or polymers, such as epoxies, acrylics, styrene acrylics, sodium silicate, or other suitable coatings or bonding materials, or other adhesive. Thus, the improved mesh made from basalt fiber or fiberglass (also known as glass fiber) such as E-glass, may be coated with water resistant and alkali resistant coating such as polyvinyl chloride (PVC), epoxies, acrylics, styrene acrylics, or sodium silicate, polyvinyl acetate, polyvinyl alcohol, ethylene vinyl acetate co-polymer, vinyl chlorides, vinyl acrylic co-polymer, styrene acrylics, styrene butadiene, polyacrylamide, polyvinyl acrylic, latex emulsions, etc. Suitable coatings include, without limitation, urea formaldehyde, melamine formaldehyde, stearated melamine formaldehyde, polyester, acrylics, polyvinyl acetate, urea formaldehyde or melamine formaldehyde modified or blended with polyvinyl acetate or acrylic, styrene acrylic polymers, and the like, as well as combinations thereof. The coating may be a latex. Examples of polymer latex binders used with or without inorganic filler are, but are not limited to: acrylic latex, Styrene-Butadiene-Rubber (SBR), Styrene-Butadiene-Styrene (SBS), Ethylene-Vinyl-Chloride (EVCI), Poly-Vinylidene-Chloride (PVdC), modified Poly-Vinyl-Chloride (PVC), Poly-Vinyl-Alcohol (PVOH), Ethylene-Vinyl-Actate (EVA), Poly-Vinyl-Acetate (PVA), and Styrene-Acrylate (SA).

Commonly used monomers for the coating polymer are butyl acrylate, methyl methacrylate, ethyl acrylate and the like. Preferably, the monomers include one or more monomers selected from the group consisting of n-butyl acrylate, methyl methacrylate, styrene, and 2-ethylhexyl acrylate.

The fabric reinforcement typically includes a plurality of warp yarns having a first twist (turns/inch) and a plurality of weft yarns having a second twist. The fabric further includes a strengthening coating disposed over a substantial portion of the warp and weft yarns. Preferably, the strengthening coating is a resinous coating that is the binder, such as in the case of a nonwoven scrim, or a finish, such as in the case of a woven or knit scrim. Preferably the resinous coating comprises alkali resistant polymer.

To increase chemical bonding to increase the cohesive tensile strength of the intersection points of the fabric the woven knit and laid scrim fabrics may be coated by applying organic or inorganic adhesives or polymers, such as epoxies, acrylics, styrene acrylics, sodium silicate, or other suitable coatings or bonding materials, either:
(a) before fabric-forming, as in single-end-coated fabrics; or:
(b) after they have been assembled or laid by in-line (normally roller or dip coated) concurrently with formation such as in the case of laid nonwoven scrims; or
(c) after they have been assembled or laid by off-line coated after formation (normally roller or dip coated), typically used with many woven fabrics.

The invention can improve the flexural strength of the cement board by strengthening the bond at intersections of the reinforcing yarns such as the fiberglass yarns. The cohesive tensile strength is the resistance to separation of cohesively bonded warp and weft yarns when a tensile force is applied to the either the warp or weft yarns. The invention improves the resistance to failure of intersections which are held together by cohesion, as measured when a tensile force is applied to the fabric. Preferably the invention increases cohesive tensile strength at least 10%, more preferably at least 30%, further more preferably at least 50%, and most preferably at least 100%, compared to conventional fiberglass fabrics coated with PVC coatings, wherein the fiberglass yarns typically comprise G75 and/or G37 yarns, and the PVC coating weight typically ranges between 45-65 wt % of the total weight of the fabric. Preferably this is typified by the cohesive tensile strength for the improved fabric of this invention typically ranging between 0.15 to 0.60 lbsf per bonded intersection point of the fabric. For example the cohesive tensile strength for the coated fiberglass fabric of this invention, typically ranging between 0.15 to 0.60 lbsf per bonded intersection point of the fabric. The cohesive tensile strength of the bonded intersection points of the fabrics of this invention is preferably greater than 0.20 lbsf, more preferably greater than 0.25 lbsf, and most preferably greater than 0.30 lbsf, per bonded intersection point of the fabric. The cohesive tensile strength of the bonded intersection points of the fabrics of this invention is typically at most 0.60 lbs, or at most 0.55 lbsf, or at most 0.50 lbsf, per bonded intersection point of the fabric. Preferably the yarns are fiberglass yarns or basalt fiber yarns. Preferably, increased chemical bonding to increase the cohesive tensile strength of the intersection points of the fabric is such that the fabric's intrinsic tensile strength is realized to increase cement board flexural strength. One way to achieve this is to increase coating weight of fabric, for example by increasing the PVC coating weight of fabric and/or the coating has a PVC coating with increased stiffness/strength. The fabric's “intrinsic tensile strength” relates to the ability of the fabric, via its tensile strength, to provide tensile reinforcement to cement boards. The full potential of this reinforcement (fabric's “intrinsic tensile strength) is aided by, and can be substantially achieved by, using the present invention, whereas it may not be achieved without the present invention.

Also, the invention may increase chemical bonding to increase the cohesive tensile strength of the intersection points of the fabric, preferably such that the fabric's intrinsic tensile strength is realized, to increase cement board flexural strength with an uncoated scrim modified to improve cement board flexural strength by adhering the strands of scrim together where machine direction and cross-machine strands intersect, for example with cyanoacrylate glue or epoxy. For example, U.S. Pat. No. 6,391,131 to Newman describe at least one way to do this. Also for example, the invention can use single end coating or roll coating, similar to how PVC is typically applied to apply the adhesive if the strands are not coated.

Also, the invention may alter bond strength of the intersecting yarns of the scrim as well as the corresponding mechanical bond of the scrim to the alkaline cementitious matrix to increase cement board flexural strength with a scrim modified by increasing the overall roughness and/or surface area of the scrim compared to an unmodified scrim. Preferably the scrim has a surface roughness value Ra of about 0.1 micron to about 1.5 micron. Roughness itself is a series of microscopic “peaks and valleys” across a surface. This becomes clearer when viewed in cross-section. Surface roughness Ra is calculated measuring the average of individual measurements of surface heights (peaks) and depths (valleys) across the surface. This measurement is most commonly shown as “Ra” for “Roughness Average”. Formally, Ra is described in ASME B46.1 as “the arithmetic average of the absolute values of the profile height deviations from the mean line, recorded within the evaluation length.” This may be achieved by embossing or roughening the coating (example, PVC coating) surface. This may also be achieved by bonding various fillers or fibers into or on the scrim coating surface. Examples of such fillers or fibers include glass fiber, basalt fiber, alkaline resistant fiber, calcium carbonate, quartz, sand, fly ash, perlite, expanded aggregate or other similar materials.

Also, this increasing of surface area may be achieved by using scrim that has an alternate weaving pattern. For example, fabrics that add a third dimension such as a pile or velvet weave may improve mechanical bonding. Preferably, surface area of the fabric is increased at least 20% compared to the conventional PVC coated fiberglass scrims used in manufacturing cement boards, for example, conventional fiberglass scrims coated with PVC coatings, wherein the fiberglass yarns typically comprise G75 and/or G37 yarns, and the PVC coating weight typically ranges between 45-65 wt % of the total weight of the scrim with conventional surface area that ranges from 1.0 to 1.05 square inch per square inch planar area of scrim. Preferably the enhanced scrim of this invention has a surface area of about 1.20 to about 2.0 square inch per square inch planar area of scrim.

The present invention can, alternatively or cumulatively, employ yarn twist, yarn tension, hydrophilic or hydrophobic coatings, and unbalanced warp-weft constructions, to bring about a more uniform overall coating application to the knit, weave, braid or scrim fabrics. In the most preferred embodiments, the fabric warp/weft twist level ratio is adjusted between the warp and weft yarns to create directional absorption of the coating so that the “coating weight distribution ratio” changes, for example, such that it is more balanced.

The fabric can, for example, be selected from laid scrim, stitch bonding or warp knitting, plain weaving, twill or satin weaving, unidirectional weaving, knitting, and knitting constructions. The typical fabric thickness is about 5-22 mils, with a binder or finish loading of about 18-250 wt. %, based on the weight of the fibers. The warp yarns, weft yarns, or both, can include glass filaments totaling 33-400 tex, and are preferably coated by a PVC-based plastisol coating. In order to further assist directional coating, the warp yarns can be treated with a hydrophilic agent prior to water based coating, or a oleophilic agent, prior to PVC-plastisol coating, and the weft yarns can be treated with an oleophobic agent prior to PVC-plastisol coating or a hydrophobic agent prior to a water based coating, for example.

The invention also provides a reinforced cementitious board which includes a cementitious core, such as those including Portland cement or gypsum, and the improved reinforcing scrim (also known as mesh or fabric) disposed on at least one face of the cementitious core. The reinforcing fabric includes a plurality of warp yarns having a first twist (turns/inch) and a plurality of weft yarns having a second twist. A resinous coating is typically applied to the fabric in a “coating weight distribution ratio” of less than about 2.0:1, based upon the weight percentage of the resinous coating on the weft yarns, over the weight percentage of the resinous coating on the warp yarns ((weft coating weight/weft yarn weight)/(warp coating weight/warp yarn weight)).

The improved reinforcing scrim is embedded on or slightly into the cementitious core. The fiberglass mesh or scrim is treated with coating such as a polyvinyl chloride thermal melt coating to resist degradation under alkaline conditions and increase the chemical and/or mechanical bond of the scrim in the cement scrim matrix.

As in the case of typical cement boards, the bottom scrim or mesh layer can be extended over the panel edge and overlap at least a portion of the top mesh or scrim to which it is adhesively attached.

Other features and advantages of the present invention will be apparent to those skilled in the art from the Detailed Description of the Preferred Embodiments presented below and accompanied by the drawings.

### BRIEF DESCRIPTION OF THE FIGURES

The present invention will be further described with reference to the following drawings:

FIG. 1 is a perspective view of a cement panel with a scrim layer embedded in the core on the top side of the cement core and, optionally embedded on the opposed side of the core, in accordance with an embodiment of the present invention.

FIG. 2 is a front perspective view of a preferred fabric of this invention employing an exemplary plain weave;

FIG. 3 is an alternative fabric of this invention depicting a five-harness satin weave;

FIG. 4 is a further embodiment of the fabric of this invention depicting a uni-directional weave;

FIG. 5 is a further embodiment of the fabric of this invention depicting a full-width plain weave with selvage;

FIG. 6 is a view of the plain weave of FIG. 5 with spacing between yarns labeled.

FIG. 7 is a side view of the fabric of FIG. 6.

FIG. 8 is a diagram of a non-woven construction pattern for a fiberglass scrim for use in making a reinforced cementitious board of the present invention.

FIG. 9 is a diagrammatic side view of an example of a continuous manufacturing line for producing a cementitious board of the invention using an improved scrim fabric.

FIG. 10 is a cross-section of the cement panel of this invention with a scrim layer embedded in the core on the top side of the cement core and, optionally embedded on the opposed side of the core.

FIG. 11 is a magnified view of a portion of the cementitious board of FIG. 10.

FIG. 11A is a magnified view of the top facing interface of a portion of the cementitious board of FIG. 10.

FIG. 12 shows two fibers adhered by adhesive.

FIG. 13 is a photograph of a test device used to test cohesive tensile strength in an example.

FIG. 14 is a drawing of a test device used to test cohesive tensile strength in an example.

### DEFINED TERMS

In accordance with the present invention, the following definitions are used:

Areal weight. The weight of coated or uncoated fabric per unit area (width*length).

Cementitious material. An inorganic hydraulically setting material, such as those containing one or more of: hydraulic cement, for example Portland cement, mortar, plaster, gypsum, and/or other ingredients, such as, foaming agents, aggregate, glass fibers, moisture repellants and moisture resistant additives and fire retardants.

Composite facing material. Two or more layers of the same or different materials including two or more layers of fabrics, cloth, knits, mats, wovens, non-wovens and/or scrims, for example.

Fabric. Woven or non-woven flexible materials, such as tissues, cloth, knits, weaves, carded tissue, spun-bonded, point-bonded, and mesh-type scrim wovens and nonwovens, needled or braided materials. The terms fabric, scrim, and mesh are interchangeably used in this document.

Fiber. A general term used to refer to filamentary materials. Often, fiber is used synonymously with filament. It is generally accepted that a filament routinely has a finite length that is at least 100 times its diameter. In most cases, it is prepared by drawing from a molten bath, spinning, or by deposition on a substrate.

Filament. The smallest unit of a fibrous material. The basic units formed during drawing and spinning, which are gathered into strands of fiber for use in composites.

Glass. An inorganic product of fusion that has cooled to a rigid condition without crystallizing. Glass is typically hard and relatively brittle, and has a conchoidal fracture.

Glass fiber. A fiber spun from an inorganic product of fusion that has cooled to a rigid condition without crystallizing.

Knitted fabrics. Fabrics produced by interlooping chains of filaments, roving or yarn.

Mat. A fibrous material consisting of randomly oriented chopped filaments, short fibers, or swirled continuous filaments held together with a binder.

Monofilaments are the long continuous single strands which are created by drawing molten glass or basalt as described above. The terms “roving”, “yarn”, and “strand” are used interchangeably in this specification to refer to a bundle of monofilaments.

Roving. A number of yarns, strands, tows, or ends collected into a parallel bundle with little or no twist.

Scrim. A reinforcing fabric made from continuous filament yarn or strand in an open-mesh construction that can be woven or laid, for example. In a triaxial scrim, plural weft yarns having both an upward diagonal slope and a downward diagonal slope are located between plural longitudinal warp yarns located on top of the weft yarns and below the weft yarns. The terms fabric, scrim, and mesh are interchangeably used in this document.

Tensile strength. The maximum load or force per unit cross-sectional area, within the gage length, of the specimen. The pulling stress required to break a given specimen. (See ASTM D579 and D3039)

Tex. Linear density (or gauge) is a unit of measure for the linear mass density of fibers, yarns and thread and is defined as the mass in grams per 1000 meters (g/km). Note that, unless otherwise indicated, any tex values stated for coated fiber is the tex value of the fiber only, without coating.

Textile fibers. Fibers or filaments that can be processed into yarn or made into a fabric by interlacing in a variety of methods, including weaving, knitting and braiding.

Warp. The yarn, fiber or roving running longitudinal or lengthwise in a woven, knit or laid or woven scrim fabric through which the weft is woven. A group of yarns, fibers or roving in long lengths and approximately parallel.

Weave. The particular manner in which a fabric is formed by interlacing yarns, fibers or roving. Usually assigned a style number. Each individual warp thread in a fabric is called a warp end.

Weft. The transverse threads or fibers in a woven, knit or laid or woven scrim fabric. Those fibers running perpendicular to the warp. Also called fill, filling, yarn or woof.

Woven fabric. A material (usually a planar structure) constructed by interlacing yarns, fibers, roving or filaments, to form such fabric patterns as plain, harness satin, or leno weaves, for example. The weft yarn is drawn through the warp yarns to create a fabric. Thus, the weft yarn is lateral or transverse relative to the warp yarn. In a triaxial scrim, plural weft yarns having both an upward diagonal slope and a downward diagonal slope are located between plural longitudinal warp yarns located on top of the weft yarns and below the weft yarns

Woven roving. A heavy glass fiber fabric made by weaving roving or yarn bundles.

Yarn. One or more fibers or filaments in a group that is handled as an entity as an input in a textile process. The fibers or filaments are either natural or manufactured and form a continuous length that is suitable for use in weaving or interweaving into textile materials. (also known as strand)

Zero-twist-yarn. A roving, i.e., a strand of near zero twist with linear densities and filament diameters typical of fiberglass yarn (but substantially without twist)

### DETAILED DESCRIPTION OF THE INVENTION

Facing materials, cementitious boards and methods of manufacturing cementitious boards having the facing materials of this invention are provided. Facing materials which are embedded totally, or only partially, so as to present a fibrous facing, are within the scope of this invention. The fabric reinforcements of this invention can be employed in many end-use reinforcement applications, such as, for example, gypsum and cement boards, asphalt and road reinforcement, roofing applications, soil reinforcement, polymer-matrix reinforcement, and as stand-alone coated fabrics in filters, screens and garment applications.

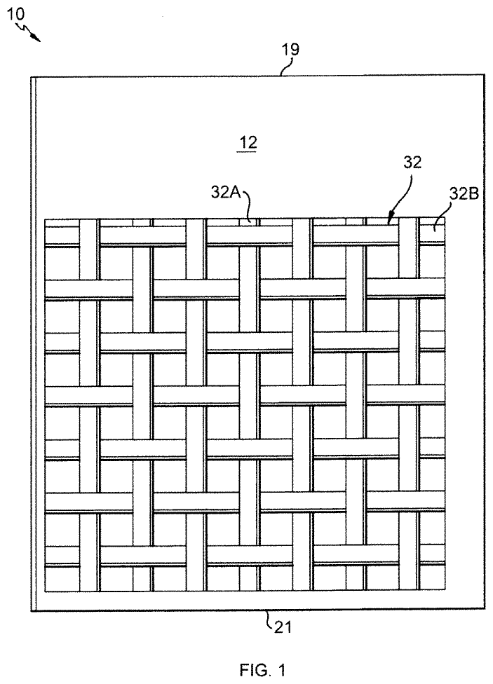

With reference to the Figures, and particularly to FIGS. 1-6 thereof, there is depicted a series of fabrics useful as the facing layer of the facing material of this invention. Needled, woven, knitted, braided and mesh-type nonwoven and composite materials are preferred because of their impressive strength-to-weight ratio and, in the case of wovens, braided, knits, and nonwoven mesh-types (also referred to as “scrim”), their ability to form weft and warp yarn patterns which can be manipulated to create directional absorption of coatings. While the facing layers of this invention can contain fibers and filaments of organic and inorganic materials, the most preferred fibers contain glass, olefin (such as polyethylene, polystyrene and polypropylene), Kevlar(R), graphite, rayon, polyester, carbon, ceramic fibers, or combinations thereof, such as glass-polyester blends or TWINTEX(R) glass-olefin composite, available from St. Gobain Corporation, France. Of these types of fibers and filaments, glass compositions are the most desirable for their fire resistance, low cost and high mechanical strength properties.

FIG. 1 schematically shows a perspective view of a cement board 10 having a cement core 12 and scrim wrapped about the core 12. The core layer 12 is made of a cement composition. The reinforcing fiberglass mesh or scrim 32 is embedded in the surface layer of the panel and can be wrapped about the core 12 to form a front layer and a back layer (not shown). The scrim 32 has warp (lengthwise or longitudinal) yarns 32A and weft (lateral or transverse) 32B yarns. The scrim or mesh layer 32 is commonly extended to its edge 21 over the panel edge 19 and overlaps at least a portion of the mesh or scrim 32 on the opposed side and is embedded in the cement core 12. The edges 21 of the core layer 12, and end portions of the scrim front layer 22 and front and back layer 32 can be wrapped to produce rounded edge corners. Because of its cementitious nature, a cement board or panel may have a tendency to be relatively brittle at its edges which often serve as points of attachment for the boards.

### Glass Composition

Although a number of glass compositions have been developed, only a few are used commercially to create continuous glass fibers. The five main glasses used are high alkali (alkali resistant or AR-glass) useful in motor or cement applications, such as in tile backing, electrical grade (E-glass), a modified E-glass that is chemically resistant (ECR-glass), a modestly chemically resistant glass (C-glass), and high strength (R or S-glass). A-glass is also available, but has limited uses. The representative chemical compositions of these five glasses are given in TABLE 1.

TABLE 1
Typical Glass Fiber Compositions (Material wt. %)
Source: ASM INTERNATIONAL, ASM Handbook, Vol. 21: Composites, Glass
Fibers (#06781G)(2001)

| Fiber | SIO₂ | B₂O₃ | Al₂O₃ | CaO | MgO | TiO₂ | Na₂O | K₂O | Fe₂O₃ | F₂ |
|---|---|---|---|---|---|---|---|---|---|---|
| Boron- | 52-56 | 4-6 | 12-15 | 21-23 | 0.4-4 | 0.2-0.5 | 0-1 | Trace | 0.2-0.4 | 0.2-0.7 |
| containing | | | | | | | | | | |
| E-glass | | | | | | | | | | |
| Boron- | 59.0 | — | 12.1 | 22.6 | 3.4 | 1.5 | 0.9 | — | 0.2 | — |
| free | | | | | | | | | | |
| E-glass | | | | | | | | | | |
| Boron- | 60.1 | — | 13.2 | 22.1 | 3.1 | 0.5 | 0.6 | 0.2 | 0.2 | 0.1 |
| free | | | | | | | | | | |
| E-glass | | | | | | | | | | |
| ECR- | 58.2 | — | 11.6 | 21.7 | 2.0 | 2.5 | 1.0 | 0.2 | 0.1 | Trace |
| glass* | | | | | | | | | | |
| D-glass | 74.5 | 22.0 | 0.3 | 0.5 | — | — | 1.0 | <1.3 | — | — |
| D-glass*** | 55.7 | 26.5 | 13.7 | 2.8 | 1.0 | — | 0.1 | 0.1 | — | — |
| S-, R, and | 60-65.5 | — | 23-25 | 0-9 | 6-11 | — | 0-0.1 | — | 0-0.1 | — |
| Te-glass** | | | | | | | | | | |
| Silica/ | 99.9999 | — | — | — | — | — | — | — | — | — |
| quartz | | | | | | | | | | |

*2.9% ZnO;
**0-1% Zr₂O₃;
***0.1% Li₂O

Inherent properties of the four glass fibers having these compositions are given in TABLE 2A, TABLE 2B and TABLE 2C.

TABLE 2A
Physical and mechanical properties of commercial glass fibers
Source: ASM INTERNATIONAL, ASM Handbook, Vol. 21: Composites, Glass Fibers
(#06781G)(2001)

| | | | | | | | | | | | Bulk |
|---|---|---|---|---|---|---|---|---|---|---|---|
| | Log 3 forming | | | | | | | | | | Density |
| | temperature | | Liquidus | | Softening | | Annealing | | Straining | | annealed |
| | (a) | | temperature | | temperature | | temperature | | temperature | | glass |
| Fiber | ° C. | ° F. | ° C. | ° F. | ° C. | ° F. | ° C. | ° F. | ° C. | ° F. | g/cm³ |
| General | | | | | | | | | | | |
| purpose | | | | | | | | | | | |
| fibers | | | | | | | | | | | |
| Boron- | 1160- | 2120- | 1065- | 1950- | 830- | 1525- | 657 | 1215 | 616 | 1140 | 2.54- |
| containing | 1196 | 2185 | 1077 | 1970 | 860 | 1580 | | | | | 2.55 |
| E-glass | | | | | | | | | | | |
| Boron- | 1260 | 2300 | 1200 | 2190 | 916 | 1680 | 736 | 1355 | 691 | 1275 | 2.62 |
| free E- | | | | | | | | | | | |
| glass | | | | | | | | | | | |
| Special | | | | | | | | | | | |
| purpose | | | | | | | | | | | |
| fibers | | | | | | | | | | | |
| ECR- | 1213 | 2215 | 1159 | 2120 | 880 | 1615 | 728 | 1342 | 691 | 1275 | 2.66- |
| glass | | | | | | | | | | | 2.68 |
| D-glass | — | — | — | — | 770 | 1420 | — | — | 475 | 885 | 2.16 |
| S-glass | 1565 | 2850 | 1500 | 2730 | 1056 | 1935 | — | — | 760 | 1400 | 2.48- |
| | | | | | | | | | | | 2.49 |
| Silica/ | >2300 | >4170 | 1670 | 3038 | — | — | — | — | — | — | 2.15 |
| quartz | | | | | | | | | | | |

(a) The log 3 forming temperature of a melt at reference viscosity of 100 Pa · s (1000 P)

TABLE 2B
Physical and mechanical properties of commercial glass fibers
Source: ASM INTERNATIONAL, ASM Handbook, Vol. 21: Composites, Glass
Fibers (#06781G)(2001)

| | | | | | Volume | | Weight |
|---|---|---|---|---|---|---|---|
| | | | Dielectric | | resistivity | | loss in |
| | Coefficient | | constant | | at room | | 24 h in |
| | of linear | Specific | at room | Dielectric | temp, | Refractive | 10% |
| | expansion | heat, | temp, and | strength, | log₁₀ (Ω | index | H₂SO₄, |
| Fiber | 10⁻⁶/° C. | cal/g/° C. | 1 MHz | kV/cm | cm) | (bulk) | % |
| General | | | | | | | |
| purpose | | | | | | | |
| fibers | | | | | | | |
| Boron- | 4.9-6.0 | 0.192 | 5.86-6.6 | 103 | 22.7-28.6 | 1.547 | about |
| containing | | | | | | | 41 |
| E-glass | | | | | | | |
| Boron- | 6.0 | — | 7.0 | 102 | 28.1 | 1.560 | about 6 |
| free E- | | | | | | | |
| glass | | | | | | | |
| Special | | | | | | | |
| purpose | | | | | | | |
| fibers | | | | | | | |
| ECR- | 5.9 | — | — | — | — | 1.576 | 5 |
| glass | | | | | | | |
| D-glass | 3.1 | 0.175 | 3.56-3.62 | — | — | 1.47 | 5 |
| S-glass | 2.9 | 0.176 | 4.53-4.6 | 130 | — | 1.523 | — |
| Silica/ | 0.54 | — | 3.78 | — | — | 1.4585 | — |
| quartz | | | | | | | |

TABLE 2C
Physical and mechanical properties of commercial glass
fibers Source: ASM INTERNATIONAL, ASM Handbook, Vol.
21: Composites, Glass Fibers (#06781G)(2001)

| | Tensile strength at | | | | Filament |
|---|---|---|---|---|---|
| | 23° C. (73° F.) | | Young's modulus | | elongation |
| Fiber | MPa | ksi | GPa | 10⁶ psi | at break, % |

General
purpose
fibers

| Boron- | 3100-3800 | 450-551 | 76-78 | 11.0-11.3 | 4.5-4.9 |
|---|---|---|---|---|---|
| containing | | | | | |
| E-glass | | | | | |
| Boron-free | 3100-3800 | 450-551 | 80-81 | 11.6-11.7 | 4.6 |
| E-glass | | | | | |
| Special | | | | | |
| purpose | | | | | |
| fibers | | | | | |
| ECR-glass | 3100-3800 | 450-551 | 80-81 | 11.6-11.7 | 4.5-4.7 |
| D-glass | 2410 | 349 | — | — | — |
| S-glass | 4380-4590 | 635-666 | 88-91 | 12.8-13.2 | 5.4-5.8 |
| Silica/quartz | 3400 | 493 | 69 | 10.0 | 5 |

The fiberglass strands may be made from E-glass which have typical physical properties listed in TABLE 3.

TABLE 3
Mechanical Properties of E-Glass

| Tensile strength (psi/GPa) | 2-3 × 10⁵/1.4-2.0 |
|---|---|
| Modulus of elasticity tension (psi/GPa) | 10.5 × 10⁶/72.4 |
| Poisson's ratio | 0.22 |
| Creep | None |
| Elongation (%) Standard (at break) | 3-4 |
| Elastic recovery (%) | 100 |

The improved fiberglass mesh used in the present invention may be made from thicker fiberglass yarn such as the DE 37, DE 50, G-50, G-37, H 12, H 25, H 55 and K 18 fiberglass yarns manufactured by PPG, AGY, and Vetrotex, and coated with alkali resistant coating. The filaments designations DE, G, H and K used by the textile industry are listed in TABLE 3A. The different yarns can be mixed and the mesh opening can be non-uniform.

Typically the fiberglass yarn in an uncoated state has a nominal linear density of 1200 to 10,000, for example 1200 to 7300, 1200 to 7000, 1200 to 8000, or 1200 to 5000, linear yards per pound of uncoated fiberglass yarn. Typically the fiberglass yarn, in an uncoated state, has a nominal density of about 3700 to 5000 linear yards per pound of fiberglass yarn. The coated fibers are typically, 40-80 wt.%, for example 40-65 wt. %, alkali resistant coating on a dry basis with the remainder being the glass fiber itself. TABLE 3A shows mechanical properties of glass yarn. TABLE 4 shows textile fibers designations.

TABLE 3A
Mechanical Properties of Glass Yarn

| | Yardage | | | |
|---|---|---|---|---|
| | Bare glass, | With binder, | | Minimum |
| | nominal linear | nominal linear | TEX Values | tensile |
| Yarn | density (linear | density (linear | (grams per | strength |
| type | yards per pound) | yards per pound) | 1000 meters) | (lbs) |
| DE37 | 3700 | 3682 | 134 | 12.0 |
| DE50 | 5000 | 4978 | 99 | 9.5 |
| G37 | 3700 | 3660 | 134 | 14.7 |
| G50 | 5000 | 4946 | 99 | 9.5 |
| G75 | 7300 | 7221 | 66 | 7.6 |
| H12 | 1215 | 1205 | 413 | 36.7 |
| H25 | 2500 | 2475 | 198 | 19.5 |
| H55 | 5500 | 5432 | 90 | 9.5 |
| K18 | 1800 | 1781 | 275 | 24.0 |

TABLE 4
Textiles Fibers Designation

| Filament | Filament | | |
|---|---|---|---|
| designation | designation | Diameter | Diameter in |
| US units | SI units | in Inches | micrometers |
| DE | 6.0 | 0.00025 | 6.35 |
| G | 9.0 | 0.00036 | 9.14 |
| H | 11.0 | 0.00043 | 10.92 |
| K | 13.0 | 0.00053 | 13.46 |

### Glass Melting and Forming

Glass Melting and Forming

The conversion of molten glass in the forehearth into continuous glass fibers is basically an attenuation process. The molten glass flows through a platinum-rhodium alloy bushing with a large number of holes or tips (400 to 8000, in typical production). The bushing is heated electrically, and the heat is controlled very precisely to maintain a constant glass viscosity. The fibers are drawn down and cooled rapidly as they exit the bushing. A sizing is then applied to the surface of the fibers by passing them over an applicator that continually rotates through the sizing bath to maintain a thin film through which the glass filaments pass. After the sizing is applied, the filaments are gathered into a strand before approaching the take-up device. If smaller bundles of filaments (split strands) are required, multiple gathering devices (often called shoes) are used.

The attenuation rate, and therefore the final filament diameter, is controlled by the take-up device. Fiber diameter is also impacted by bushing temperature, glass viscosity, and the pressure head over the bushing. The most widely used take-up device is the forming winder, which employs a rotating collet and a traverse mechanism to distribute the strand in a random manner as the forming package grows in diameter. This facilitates strand removal from the package in subsequent processing steps, such as roving or chopping. The forming packages are dried and transferred to the specific fabrication area for conversion into the finished fiberglass roving, mat, chopped strand, or other product. In recent years, processes have been developed to produce finished roving or chopped products directly during forming, thus leading to the term direct draw roving or direct chopped strand.

### Basalt Composition

Basalt is an inert rock found worldwide in abundance as solidified volcanic lava, and is known for its thermal properties, strength, and durability. According to manufacturers, basalt roving delivers exceptional properties when used in woven, non-woven or chopped form and it has high resistance to corrosion, chemicals, alkaline, acid and solvents. They also claim basalt reinforcements are energy-efficient and lightweight compared to traditional materials such as steel or aluminum and compare favorably to other composite fibers like carbon or fiberglass.

Basalt fiber is produced by melting basalt rock and then drawing it into long, continuous filaments which solidify as they cool, similar to fiberglass. The solidified filaments are treated with sizing and twisted together to create continuous basalt fiber. The chemical composition and mechanical properties of basalt fiber can vary significantly. According to Irvine and Baragar's 1971 paper “A Guide to the Chemical Classification of the Common Volcanic Rocks”, Basalt generally has a composition of 45-52 wt % SiO₂, 2-5 wt % total alkalis, 0.5-2.0 wt % TiO₂, 5-14 wt % FeO and 14 wt % or more Al₂O₃. Contents of CaO are commonly near 10 wt %, those of MgO commonly in the range 5 to 12 wt %.

TABLE 5A and TABLE 5B show properties of typical basalt fiber products.

TABLE 5A
BASALT PRODUCTS

| | | | | | | Target | Target | T arget | Target |
|---|---|---|---|---|---|---|---|---|---|
| | | | Yield | Filament | | Package | Package | length | Length |
| Class | Product | Tex | (yds/lb) | diameter | Sizing | Wt. (kg) | Wt (lbs) | (m) | (yards) |
| Direct | A | 68 | 7295 | 9 | 041 | 5 | 11 | 73,529 | 80,413 |
| Roving | B | 80 | 6201 | 9 | 041 | 5 | 11 | 62,500 | 68,351 |
| (DR) | C | 100 | 4961 | 10 | 02L | 5 | 11 | 50,000 | 54,681 |
| | D | 150 | 3307 | 13 | 02L | 7 | 15 | 46,667 | 51,035 |
| | E | 150 | 3307 | 13 | 041 | 7 | 15 | 46,667 | 51,035 |
| | F | 150 | 3307 | 13 | 5 × 1 | 7 | 15 | 46,667 | 51,035 |
| | G | 300 | 1654 | 13 | 041 | 7 | 15 | 23,333 | 25,518 |
| | H | 425 | 1167 | 13 | 041 | 10 | 22 | 23,529 | 25,732 |
| | 1 | 500 | 992 | 17 | 04 | 10 | 22 | 20,000 | 21,872 |
| | J | 600 | 827 | 19 | 041 | 10 | 22 | 16,667 | 18,227 |
| | K | 600 | 827 | 19 | 5 × 1 | 10 | 22 | 16,667 | 18,227 |
| Assembled | L | 425 | 1167 | 13 | 041 | 15 | 33 | 35,294 | 38,598 |
| Roving | M | 800 | 620 | 13 | 041 | 15 | 33 | 18,750 | 20,505 |
| (AR) | N | 1200 | 413 | 13 | 041 | 15 | 33 | 12,500 | 13,670 |
| | O | 1200 | 413 | 19 | 041 | 15 | 33 | 12,500 | 13,670 |
| | P | 2400 | 207 | 19 | 041 | 15 | 33 | 6.250 | 6,835 |
| | Q | 2400 | 207 | 19 | 5 × 1 | 15 | 33 | 6,250 | 6,835 |
| | R | 3000 | 165 | 15 | 041 | 15 | 33 | 5,000 | 5,468 |
| | S | 3000 | 165 | 17 | 5 × 1 | 15 | 33 | 5,000 | 5,468 |

TABLE 5B

| | | % | % | Tenacity | Tensile | Tensile | | |
|---|---|---|---|---|---|---|---|---|
| Class | Product | LOI | Moisture | (Cn/Tex) | (N) | (lbf) | Twist | Packaging |
| Direct | A | 0.80 | 0.03 | 83.8 | 57.0 | 12.8 | 0 | Inside Pull |
| Roving | B | 0.80 | 0.02 | 74.3 | 59.4 | 13.4 | 0 | Inside Pull |
| (DR) | C | 0.50 | 0.01 | 75.7 | 75.7 | 17.0 | 0 | Inside Pull |
| | D | 0.50 | 0.03 | 71.7 | 107.6 | 24.2 | 0 | Inside Pull |
| | E | 0.70 | 0.04 | 78.6 | 117.9 | 26.5 | 0 | Inside Pull |
| | F | 0.80 | 0.02 | 80.0 | 120.0 | 27.0 | 0 | Inside Pull |
| | G | 0.70 | 0.03 | 79.1 | 237.3 | 53.3 | 0 | Inside Pull |
| | H | 0.70 | 0.01 | 77.0 | 327.4 | 73.6 | 0 | Inside Pull |
| | 1 | 0.70 | 0.02 | 68.8 | 344.1 | 77.4 | 0 | Inside Pull |
| | J | 0.80 | 0.03 | 64.3 | 386.0 | 86.8 | 0 | Inside Pull |
| | K | 0.80 | 0.03 | 66.0 | 396.1 | 89.0 | 0 | Inside Pull |
| Assembled | L | 0.70 | 0.01 | 73.1 | 310.8 | 69.0 | 0 | Tube/inside |
| Roving | M | 0.80 | 0.01 | 74.0 | 591.7 | 133.0 | 0 | Tube/inside |
| (AR) | N | 0.80 | 0.04 | 67.5 | 809.5 | 182.0 | 0 | Tube/inside |
| | O | 0.80 | 0.01 | 63.5 | 762.4 | 171.4 | 0 | Tube/inside |
| | P | 0.80 | 0.02 | 60.5 | 1452.0 | 326.4 | 0 | Tube/inside |
| | Q | 0.80 | 0.02 | 61.4 | 1473.6 | 331.3 | 0 | Tube/inside |
| | R | 0.80 | 0.02 | 61.6 | 1846.8 | 415.2 | 0 | Tube/inside |
| | S | 0.80 | 0.02 | 58.4 | 1752.0 | 393.9 | 0 | Tube/inside |

### Fabrication Process

Once the continuous glass fibers or basalt fibers have been produced they must be converted into a suitable form for their intended application. The major finished forms are continuous roving, woven roving, fiberglass mat, chopped strand, and yarns for textile applications.

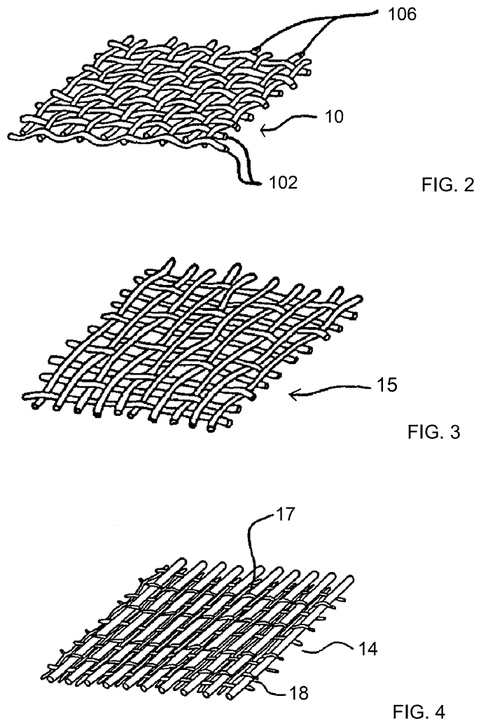

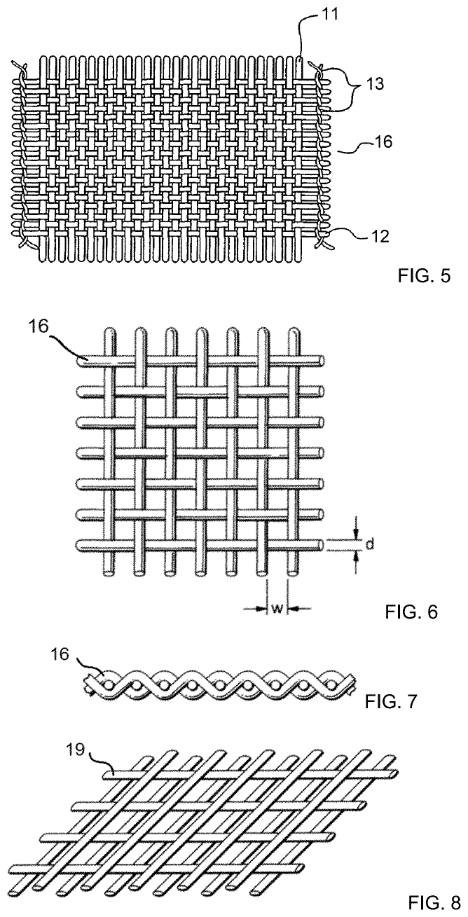

The fabric 10 of the invention can be made in many constructions, such as those shown in FIGS. 1-8 and can be made by conventional means such woven by plain weaving (FIG. 5, 6, 7), twill or satin weaving (FIGS. 2-3) or unidirectional weaving (FIG. 4) or warp knitting or stitchbonding (not shown). FIG. 8 is a diagram of a non-woven (also known as a laid scrim) construction pattern for a glass fiber or basalt fiber scrim for use in making a reinforced cementitious board of the present invention.

Zero twist-yarns may also be used. This input can offer the ease of spreading of (twistless) roving with the coverage of fine-filament yarns. The number of filaments per strand used directly affects the porosity and is related to yarn weight as follows: n=(490*Tex)/d<2>, where “d” is the individual filament diameter expressed in microns. Thus, if the roving with coarse filaments can be replaced with near zero twist yarn with filaments half the diameter, then the number of filaments increases by a factor of 4 at the same strand Tex.

The major characteristics of the knit or woven facing embodiments of this invention include its style or weave pattern, fabric count, and the construction of warp yarn and fill yarn. Together, these characteristics determine fabric properties such as drapability and performance in the final board. The fabric count identifies the number of warp and fill yarns per inch. Warp yarns run parallel to the machine direction, and fill yarns are perpendicular.

Woven, knit, braided or mesh-type (scrim) nonwoven fabrics can be coated with water-based resin, oil-based resin or 100% solid coatings to impart strength, provide corrosion or fire resistance, pigmentation and/or other properties. When the input yarns are of significant twist (over 0.1 turns/inch), this twist affects the ratio of coating weight in the weft or cross-machine direction versus the coating weight in the warp or machine direction (“coating weight distribution ratio”). Coating weight is often measured in the Wet Pick Up (WPU) % or Dry Pick Up (DPU) %, which are the ratios of wet or dry coating weight to yarn weight, respectively. For a typical plain weave fabric having multi-filament weft and warp yarns or roving, a typical twist in both the warp and weft yarns is about 0.7 turns/inch. This creates a “coating weight distribution ratio” (WPU_{cd}/WPU_{md}) of about 2.5:1. The reason for this asymmetry in coating weight is that the tension in the machine direction, or warp yarns, is normally much higher than that in the cross-machine direction, or weft yarns, at the time of the coating operation. This is due to the normal tension necessary to pull the fabric through the continuous processing operations, which often include sequential coating, drying and winding steps. The tendency of a fabric to resist absorption of coating in the warp direction is roughly correlated to the following formula: WPU_{md}=F(twist frequency*tension*wetting parameter).

The same relationship exists for the weft or cross-machine direction yarns, but since the cross-machine or weft yarns are normally under low tension, the yarns in this direction preferentially absorb or pick up more coating than the yarns in the warp direction. Thus, the ratio WPU_{cd}/WPU_{md} reflects an imbalance, with more coating being applied to the weft, or cross-machine direction yarns.

In the most preferred embodiments of this invention, the coating weight distribution ratio is less than about 2.0:1, and preferably, is less than about 1.5:1, with an ideal ratio being about 1:1, for example, if all twist is removed from the warp yarns.

### Fabric Design

There are basically five weave patterns: plain, basket, twill, satin and leno. Plain weave is the simplest form, in which one warp yarn interlaces over and under one fill yarn. Basket weave has two or more warp yarns interlacing over and under two or more fill yarns. Twill weave has one or more warp yarns over at least two fill yarns. Satin weave (crowfoot) consists of one warp yarn interfacing over three and under one fill yarn, to give an irregular pattern in the fabric. The eight harness satin weave is a special case, in which one warp yarn interlaces over seven and under one fill yarn to give an irregular pattern. In fabricating a board, the satin weave gives the best conformity to complex contours, such as around corners, followed in descending order by twill, basket, and plain weaves.

Texturizing is a process in which the textile yarn is subjected to an air jet that impinges on its surface to make the yarn “fluffy”. The air jet causes the surface filaments to break at random, giving the yarn a bulkier appearance. The extent to which this occurs can be controlled by the velocity of the air jet and the yarn feed rate. An equivalent effect can be produced by electrostatic or mechanical manipulation of the fibers, yarns or roving.

The fabric pattern, often called the construction, is an x, y coordinate system. The y-axis represents warp yarns and is the long axis of the fabric roll (typically 30 to 150 m, or 100 to 500 ft.). The x-axis is the fill direction, that is, the roll width (typically 910 to 3050 mm, or 36 to 120 in.). Basic fabrics are few in number, but combinations of different types and sizes of yarns with different warp/fill counts allow for hundreds of variations.

Basic fabric structures include those made by woven, non-woven and knit processes. In this invention, one preferred design is a knit structure in which both the x axis strands and the y axis strands are held together with a third strand or knitting yarn. This type of knitting is weft-inserted-warp knitting. If an unshifted tricot stitch is used, the s and y axis strands are the least compressed and, therefore, give the best coverage at a given areal weight. This structure's coverage can be further increased, i.e., further reduction in porosity, by using near-zero-twist-yarn or roving which, naturally, spreads more than tightly twisted yarn. This design can be further improved by assisting the spreading of filaments by mechanical (needling) means, or by high-speed air dispersion of the filaments before or after fabric formation.

The most common weave construction is the plain weave shown by the fabric 10 in FIG. 2. The essential construction requires only four weaving yarns: two warp yarns 106 and two fill or weft yarns 102. This basic unit is called the pattern repeat. Plain weave, which is the most highly interlaced, is therefore the tightest of the basic fabric designs and most resistant to in-plane shear movement. Basket weave, a variation of plain weave, has warp and fill yarns that are paired: two up and two down. The satin weave 15 represent a family of constructions with a minimum of interlacing. In these, the weft yarns periodically skip, or float, over several warp yarns, as shown in FIG. 3. The satin weave 15 repeat is x yarns long and the float length is x−1 yarns; that is, there is only one interlacing point per pattern repeat per yarn. The floating yarns that are not being woven into the fabric create considerable loose-ness or suppleness. The satin weave 15 produces a construction with low resistance to shear distortion and is thus easily molded (draped) over common compound curves. Satin weaves can be produced as standard four-, five-, or eight-harness forms. As the number of harnesses increases, so do the float lengths and the degree of looseness making the fabric more difficult to control during handling operations. Textile fabrics generally exhibit greater tensile strength in plain weaves, but greater tear strength in satin weaves. The ultimate mechanical properties are obtained from unidirectional-style fabric 14 (FIG. 4), where the carrier properties essentially vanish when attached to a set cementitious core 101. The higher the yarn interlacing (for a given-size yarn), the fewer the number of yarns that can be woven per unit length. The necessary separation between yarns reduces the number that can be packed together. This is the reason for the higher yarn count (yarns/in.) that is possible in unidirectional material and its better physical properties.

A plain weave 16 having glass weft 11 and warp 12 yarns or roving, in a weave construction is known as locking leno, which is used only in special areas of the fabric, such as the selvage, and is woven on a shuttleless loom. The gripping action of the intertwining leno yarns anchors or locks the open selvage edges produced on rapier looms. The leno weave helps prevent selvage 13 (FIG. 5) unraveling during subsequent handling operations. However, it has found applications where a very open (but stable) weave is desired. FIG. 6 labels the width “w” between yarns and labels diameter “d” of a yarn of a plain weave 16. FIG. 7 shows a side view of the plain weave 16.

FIG. 8 is a diagram of a non-woven (also known as a laid scrim) construction pattern for a fiber scrim for use in making a reinforced cementitious board of the present invention. A laid scrim looks like a grid or lattice. It is made from continuous filament products (yarns). In order to keep the yarns in the desired right-angled position it is necessary to join these yarns together. In contrast to woven products the fixation of the warp and weft yarns in laid scrims must be done by chemical bonding. In the laid scrim process, warp yarns are fed from a beam or directly from a creel in the machine direction; this is followed by laying cross yarns (weft yarns) at high speed, alternating above and below the pre-laid warp yarns. The laid scrim is then immediately impregnated and coated with an adhesive coating to ensure the fixation of warp and weft yarns. The coated scrim is then dried and continuously wound on a tube for further processing.

In the present invention, conventional fiberglass scrims are replaced with new scrims which are made from fiberglass or basalt fiber strands made in the form of yarns or rovings which are constructed into scrim from bundles of fiberglass or basalt fiber strands. For example, typical fiberglass strands are made from E-glass. Table 4 lists properties of the fiber glass yarns which are used to make both conventional scrim, such as the G75 yarn commercially available AGY Holdings Corp. (Aiken, S.C.), and Saint Gobain Vetrotex America (Huntersville, N.C.) scrim, and the improved scrim used in making the cement board products of the present invention, such as the G-50 and G-37 yarns also available from AGY and Saint Gobain Vetrotex are used to make the improved scrim of the invention.

The invention for example may employ any of a variety of scrim configurations (for example, 8×8, 8×5 and 8×4) in cement board.

However, optionally the scrim used in the present invention can be made from the fiberglass yarn or basalt fiber yarn into scrim having less strands per inch in both the longitudinal (machine) and transverse (cross machine) directions for a mesh with about 4×4 to 6×6, preferably in the range of 4×4 to 5×5 strands per inch, e.g. 4×5 or 4.5×5. This results in a scrim with a larger grid opening than was considered useful by one skilled in the art. This scrim may also provide more open construction and employ thicker yarns. This produces a reinforced cement board with improved processability, long term durability, field performance, and more uniform distribution of the scrim on the surfaces of the cement board wherein the scrim is embedded in the cementitious slurry before drying of the formed cement board.

Optionally, the yarn used for making the warp and weft can have 0.7Z-3.0Z twists per inch. Optionally, the tex values of the yarns used for the G37 is 134 and 99 for the G50 compared to 66 for the G75.

### Scrim Coatings

The design of fabric 10 suitable for this invention includes fabric parameters: type of fiber, type of yearn, weave style, yarn count, and areal weight. Fiber and scrim manufacturing involves sizing (in some instances also known as binder) and may additionally involve a coating. The sizing is applied to the glass or basalt fibers during yarn manufacture. Sizing is an ultra-thin coating (<1 micron) done during fiber fabrication. This sizing is usually applied in small amounts such as 1-2.5% by weight of the fiber. After applying sizing to the yarn a coating may be applied in one or more stages to the scrim and/or to before forming the scrim. For example, a coating may be applied to yarn prior to forming the scrim and then a coating may be applied to the scrim. The total of all coating is preferably applied in an amount from 10 to 80% of the total weight of the coated basalt fiber or fiberglass fabric, more preferably in an amount from 20 to 80%, 20 to 70%, or 20 to 50% of the weight of the coated basalt fiber or fiberglass fabric.

When the preferred basalt or glass fibers are employed, a sizing is generally used. Preferred sizings for use with a fibrous layer comprised of basalt or glass filaments include aqueous sizings comprising one of the following blends: 1) an epoxy polymer, vinyl and amine coupling agents and a non-ionic surfactant; 2) an epoxy polymer, amine coupling agent and a non-ionic surfactant; 3) an epoxy polymer, methacrylic and epoxy coupling agents, and cationic and non-ionic surfactants (paraffin lubricants); 4) anhydrous polymerized acrylate amine (for example, the substance disclosed in PCT Patent Application No. WO 99/31025, which is incorporated herein by reference), methacrylic and epoxy coupling agents and a non-ionic surfactant; and 5) anhydrous polymerized epoxy amine (for example, as disclosed in U.S. Pat. No. 5,961,684 to Moireau et al., which is incorporated herein by reference), vinyl and amine coupling agents, and a non-ionic surfactant, each of the above blends being produced by Cem FIL Reinforcements of Saint Gobain Vetrotex Cem-FIL(R) S.L., a Saint Gobain Vetrotex company. Preferably, the non-ionic surfactant comprises an organo-silane. These sizings are compatible with the preferred coatings for the preferred fabric 10 and the cementitious core 101, and improve initial fiber strength and ease of fabric forming. The sizings preferably comprise not more than 2.5% by weight, and most preferably less than 1.5% by weight of the fibrous layer. The coatings are typically also selected from polyvinyl chloride (PVC), polyvinyl alcohol (PVA), polyvinyl acetate (PVAc), polyester, acrylics, acrylonitrile, silane, silicones, styrene-butadiene, polypropylene, polyethylene and epoxy.

As mentioned above, a coating may be applied to the scrim or to yarn to which the sizing has been applied before forming the scrim (reinforcing fabric). Chemical bonding of the scrim strands (yarns) may increase by applying one or more coatings of organic or inorganic adhesives or polymers, such as epoxies, acrylics, styrene acrylics, sodium silicate, or other suitable coatings or bonding materials, or other adhesive. Thus, the improved mesh made from basalt fiber or fiberglass such as E-glass, and may be coated with water resistant and alkali resistant coating such as polyvinyl chloride (PVC), epoxies, acrylics, styrene acrylics, or sodium silicate, polyvinyl acetate, polyvinyl alcohol, ethylene vinyl acetate co-polymer, vinyl chlorides, vinyl acrylic co-polymer, styrene acrylics, styrene butadiene, polyacrylamide, polyvinyl acrylic, latex emulsions, etc. Suitable coatings include, without limitation, urea formaldehyde, melamine formaldehyde, stearated melamine formaldehyde, polyester, acrylics, polyvinyl acetate, urea formaldehyde or melamine formaldehyde modified or blended with polyvinyl acetate or acrylic, styrene acrylic polymers, and the like, as well as combinations thereof. The coating may be a latex. Examples of polymer latex binders used with or without inorganic filler are, but are not limited to: acrylic latex, Styrene-Butadiene-Rubber (SBR), Styrene-Butadiene-Styrene (SBS), Ethylene-Vinyl-Chloride (EVCI), Poly-Vinylidene-Chloride (PVdC), modified Poly-Vinyl-Chloride (PVC), Poly-Vinyl-Alcohol (PVOH), Ethylene-Vinyl-Actate (EVA), Poly-Vinyl-Acetate (PVA), and Styrene-Acrylate (SA).

Typically, the coating comprises an alkali resistant coating on the fiberglass fabric that is selected from the group of polyvinyl chloride, polyvinyl alcohol, polyvinyl acetate, polyester, acrylics, acrylonitrile, silicones, styrene-butadiene, polypropylene, epoxy and polyethylene, and mixtures thereof.

The coating polymer is preferably derived from at least one acrylic monomer selected from the group consisting of acrylic acid, acrylic acid esters, methacrylic acid, and methacrylic acid esters. For example, the polymer can be a butyl acrylate/methyl methacrylate copolymer or a 2-ethylhexyl acrylate/methyl methacrylate copolymer. For example, the at least one polymer can be a butyl acrylate/methyl methacrylate copolymer or a 2-ethylhexyl acrylate/methyl methacrylate copolymer. Typically, the at least one polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C4-C8 conjugated dienes such as 1,3-butadiene, isoprene or chloroprene.

For example, the coating polymer can be a pure acrylic, a styrene acrylic, a vinyl acrylic or an acrylated ethylene vinyl acetate copolymer.

The pure acrylics preferably comprise acrylic acid, methacrylic acid, an acrylate ester, and/or a methacrylate ester as the main monomers). The styrene acrylics preferably comprise styrene and acrylic acid, methacrylic acid, an acrylate ester, and/or a methacrylate ester as the main monomers. The vinyl acrylics preferably comprise vinyl acetate and acrylic acid, methacrylic acid, an acrylate ester, and/or a methacrylate ester as the main monomers. The acrylated ethylene vinyl acetate copolymers preferably comprise ethylene, vinyl acetate and acrylic acid, methacrylic acid, an acrylate ester, and/or a methacrylate ester as the main monomers. The monomers can also include other main monomers such as acrylamide and acrylonitrile, and one or more functional monomers such as itaconic acid and ureido methacrylate, as would be readily understood by those skilled in the art. In a particularly preferred embodiment, the film-forming polymer is a pure acrylic such as a butyl acrylate/methyl methacrylate copolymer derived from monomers including butyl acrylate and methyl methacrylate.

The coating may be a latex, for example acrylic latex. A latex is a stable dispersion (emulsion) of polymer microparticles in an aqueous medium. Examples of polymer latex binders used with the inorganic fillers are, but are not limited to: Styrene-Butadiene-Rubber (SBR), Styrene-Butadiene-Styrene (SBS), Ethylene-Vinyl-Chloride (EVCI), Poly-Vinylidene-Chloride (PVdC), modified Poly-Vinyl-Chloride (PVC), Poly-Vinyl-Alcohol (PVOH), Ethylene-Vinyl-Actate (EVA), Poly-Vinyl-Acetate (PVA), and Styrene-Acrylate (SA). No asphalt is used as a binder in this invention. The coating may comprise polymers derived from versatic acid and/or versatic acid esters as disclosed by U.S. published patent application 2010/0087114 to Bush et al incorporated herein by reference. A suitable latex may also be one comprising carboxylated styrene butadiene (SBR).

Synthetic latexes are typically made by emulsion polymerization. Emulsion polymerization is a type of radical polymerization that usually starts with an emulsion incorporating water, monomer, and surfactant. For example, suitable synthetic latexes comprising acrylates are made by polymerizing a monomer such as acrylic acid emulsified with surfactants to make an acrylic latex, preferably an acrylic latex polymer comprised of an acrylic or vinyl ester of a versatic acid isomer.

The most common type of emulsion polymerization is an oil-in-water emulsion.

Combining fibers with very different properties can provide the fabric, for example fabric 10 of FIG. 2, with good longitudinal strength/stiffness values, as well as transverse (fill direction) toughness and impact resistance. The ability to hybridize the fabric 10 allows the board designer the freedom to build cementitious boards with different and perhaps conflicting requirements without major compromises. It is also possible to “teach” the looms new tricks, particularly in three-directional weaving, but interesting modifications are even possible for two-directional fabric. The loom has the capability of weaving an endless helix using different warp and fiber fill. Alternatively, a glass textile roving warp 17 and olefin weft 18, such as polyethylene or polystyrene fiber, can be used, as shown in FIG. 3. Alternatively, blends such as TWINTEX(R) glass-polyolefin blends produced by Saint-Gobain S.A., or individual multiple layers of polymers, elastomerics, rayon, polyester and glass filaments can be used as roving or yarn for the facing material, or as additional bonded or sewn layers of woven, knitted felt or non-woven layers.

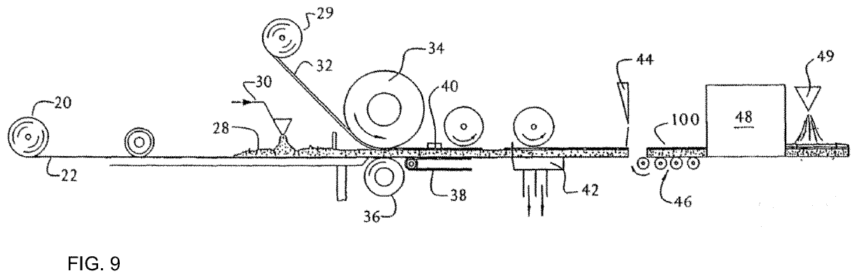

A typical coating loading ratio of basalt or glass fiber: coating (including all coatings) is about 0.2 to about 2.5 (20-250 wt. %), typically about 0.20 to about 2.0 (20-200 wt. %) coating on the fabric 10 or reinforcement of this invention. The coating preferably represents the resinous coating 107 of this invention, shown in FIG. 9, and can provide desirable properties, such as strengthening the scrim, stiffening the scrim, slurry penetration resistance, adherence to the core or other layers or materials, hydrophobic or hydrophilic properties, or a combination of these properties. In nonwoven scrim (also known as, laid scrim) embodiments of this invention, the resinous coating 107 is typically in at least a sufficient amount to bind the fibers and provide finishing properties; in woven or knit scrim embodiments, the resinous coating 107 is typically in at least a sufficient amount to provide finishing properties. In addition to the amount of coating for binding and/or finishing there may be additional coating in the resinous coating 107. The amounts of coating or binding and/or finishing as well as additional coating, if any, can be used separately or together, and can contain the same or different resinous compositions. Such coatings can enable water vapor, slurry, or both, to pass through the facing during board manufacturing. Such coatings also increase chemical bonding to increase the cohesive tensile strength of the intersection points of the fabric such that the fabric's intrinsic tensile strength is realized. These coatings may or may not completely coat the exterior facing fibers. In a more preferred embodiment, these coating should virtually completely encapsulate each strand or yarn unless good wetting and penetration allow protection of the large number of interior fibers independent of whether the exterior fibers of the bundle are also encapsulated. In this case some exposed fibers are acceptable to enable attachment.

Some exposed fibers enable attachment to factory or field applied coatings or adhesives such as Portland cement based mortar, acrylic adhesive, silicone adhesive and glue on the outer surface of the cementitious board. The selected binders and finishes should also minimize “blocking” (adhesive bonding between adjacent boards during storage). Various coatings are appropriate for this purpose, such as, for example, PVC-based plastisols, phenolic binders, urea formaldehyde resin, or urea formaldehyde resin modified with acrylic, styrene acrylic, with or without carboxylated polymers as part of the molecule, or as a separate additive. Additionally, these coatings can be provided with additives, such as UV and mold inhibitors, fire retardants, etc. Carboxylated polymer additions to the binder resin can promote greater affinity to set gypsum, or to Portland cement-based mortars, for example, but are less subjected to blocking than resins without such additions. One particularly desirable binder resin composition is a 70 wt % urea formaldehyde resin-30 wt % styrene acrylic latex or an acrylic latex mixture, with a carboxylated polymer addition.

The coatings for binding and/or finishing can be applied in 1, 2 or 3 layers or passes.

As mentioned above, in addition to the sizing and the amount of coating for binding and/or finishing there may be additional coating in layer 107 of the same or different composition as the sizing and the coating to finish and/or to bond the fibers together to form the individual layers, as described above, but can be the same or different composition. The additional coating in the resinous coating 107 can include those described in U.S. Pat. No. 4,640,864, which is hereby incorporated by reference, and are preferably water-resistant and/or fire-retardant in nature. They are preferably applied during the manufacture of the fabric 10 of this invention, but may be applied by the board manufacturer prior to use in making cementitious boards.

The additional coating in the resinous coating 107 applied to the fabric 100, as shown in FIG. 7 of this invention, preferably coats of the warp strands 106 and weft strands 102 of fabric 100. Alternatively, the additional coating in the resinous coating 107 can increase or decrease the wetting angle of the cementitious slurry to reduce penetration or increase adhesion. The coating 107 can further contain a UV stabilizer, mold retardant, alkali-resistant formulation, water repellant, a flame retardant and/or other optional ingredients, such as dispersants, catalysts, fillers and the like. Preferably, the coating 107 is in liquid form and the fabric 10 is led through the liquid, or the liquid is sprayed (with or without a water spray precursor) on one or both sides of the fabric 100 while the fabric is in tension.

Various methods of applying the additional coating 107 may be used, including dip-coaters, doctor blade devices, roll coaters and the like. One preferred method of treating the facing material with the additional coating for the resinous coating 107 of this invention is to have a lower portion of one roll partially submerged in a trough of the liquid resinous composition and the fabric 100 pressed against the upper portion of the same roller so that an amount of the resinous composition is transferred to the fabric 100. The second roller above the first roller controls the movement of the fabric 100 and the uniformity of the amount of additional coating in the resinous coating 107 disposed thereon. Thereafter, the coated fabric 100 is led in a preferred method to steam cans to expedite drying. It is preferred to pass the coated fabric 100 over steam cans at about 250-450° F. (100-200° C.) which drives the water off, if a latex is used, and additionally may cause some flow of the liquid resinous material to coat further and more uniformly fibers within the facer material. The additional coating in the resinous coating 107 preferably covers about 50-80% of the surface area targeted, more preferably about 80-99% of said area.

In the non-woven process, there are no separate stages for coating and overlaying and attaching the yarn. The raw fiberglass yarns are overlayed, and are then transported through a coating bath, where the yarns pick up the coating. The coating then cures and bonds the yarns to form a mesh. A common scrim construction of a non-woven scrim is shown in FIG. 8. The first warp thread under a weft thread is followed by a warp thread above the weft thread. This pattern is repeated across the whole width. Two threads will always meet at the intersections.

The preferred additional coating of this invention can contain a resinous mixture containing one or more resins. The resin can contain solid particles or fibers which coalesce or melt to form a continuous or semi-continuous coating over and through the yarns. The coating can be applied in various thicknesses, such as for example, to sufficiently cover the fibrous constituents of the fabric 10 so that no fibers protrude from the added coating, or to such a degree that the fibers protrude from the added coating so that they can be used to join to additional layers in a EIF system or to mortar for tile, for example. The additional coating can form an alkali barrier which protects the fabric from alkaline cement cores, for example.

The additional coating can comprise a thermoplastic or a thermoset resin.

The additional coating can be formed from a mixture of resin and fillers, such as silicates, silica, gypsum, titanium dioxide and calcium carbonate. The additional coating 107 can be applied in latex or curable thermosetting form. Acceptable resins include styrene-acrylic copolymer, acrylics, flame retardant acrylics or brominated monomer additions to acrylic, such as PYROPOLY AC2001, poly(vinyl acetates), poly(vinyl alcohols), vinylidene chloride, siloxane, and polyvinylchloride such as VYCAR (R) 578. In addition, fire retardants, such as bromated phosphorous complex, halogenated paraffin, colloidal antimony pentoxide, borax, unexpanded vermiculite, clay, colloidal silica and colloidal aluminum can be added to the resinous coating or saturant. Furthermore, water resistant additives can be added, such as paraffin, and combinations of paraffin and ammonium salt, fluorochemicals designed to impart alcohol and water repellency, such as FC-824 from 3M Co., organo hydrogen polysiloxanes, silicone oil, wax-asphalt emulsions and poly(vinyl alcohol) with or without a minor amount a minor amount of poly(vinyl acetate). The added coating can include pigment, such as kaolin clay, or lamp black thickeners such as modified bentonite clay, defoamers, such as fatty acid/polyglycol mixtures, UV resistance additives, setting accelerators, such as clay compounds, polyacrylamide, potassium salts, or combinations thereof, and dispersants such as sodium polyacrylate. Known preservatives and, of course, water can be added in latex compositions, and solvents in thermosetting compositions. (See, for example, U.S. Pat. No. 4,640,864, which includes insulation boards including polyvinylchloride based coatings including fire- and water-repellants, and which is hereby incorporated by reference). Other additives, suggested herein as being useful in the sizing and the amount of coating for binding and/or finishing, or the cementitious core 101, could also be employed in the added coating.

The preferred fabric 10 and additional coating 107 can provide long term durability in the highly alkaline environment of a cementitious core 101 where the matrix is comprised of materials such as cement paste, mortar, gypsum, concrete and/or geopolymers. The fabric 10 may be comprised of basalt fibers, glass fibers, PVA fibers, carbon fibers, olefin fibers or aramid fibers, for example, or any combination thereof. Most preferably, the fabric 10 contains glass fibers disposed in multifilament yarns. E-glass, AR-glass, A-glass, S-glass or ECR-glass is acceptable. AR-glass is desirable because it has a high degree of resistance to alkali attack and a higher strength retention over time. This is due to the presence of an optimum level of Zirconia (ZrO2), e.g. preferably about 10% to about 25% ZrO2, in the glass fibers. This type of glass exhibits a high degree of chemical resistance, resisting the very high alkalinity produced by the hydration of cementitious materials such as ordinary Portland cement. In addition, AR-glass has superior strengthening properties necessary for use in earthquake and explosion-resistant applications. It has high tensile strength and modulus and does not rust. Other glass fibers may be employed, such as E-glass, ECR-glass, C-glass, S-glass and A-glass, which are not inherently alkali-resistant, but are acceptable when coated with an alkali-resistant material, such as the disclosed polyvinyl chloride resinous coating.

The resinous coating 107 as shown in FIG. 11, is preferred where the fibrous layer is comprised of glass; however, coatings are not necessary where the fibrous layer is comprised of AR-glass, PVA, carbon or aramid fibers. The resinous coating 107 desirably provides mechanical and chemical protection to the glass fibrous layers 12. The resinous coating 107 is preferably an acrylate and/or vinyl chloride containing a polymer or polymers, such as acrylic or PVC plastisol, but may be poly-vinyl alcohol (PVA), styrene-butadiene rubber (SBR), polyolefin, acrylic acid, unsaturated polyesters, vinyl ester, epoxies, polyacrylates, polyurethanes, polyolefins, phenolics, and the like. Preferably the resinous coating comprises alkali resistant polymer. Examples of preferred coatings include an acrylic coating manufactured by Saint-Gobain Technical Fabrics, a Saint-Gobain company, under the label number 534 and a PVC plastisol coating manufactured by Saint-Gobain Technical Fabrics under the label number V38. The use of PVC plastisol as a coating further improves the alkali resistance of the fibrous layer in the inorganic matrix. The use of acrylic as a coating promotes adherence of the fibrous layer to an inorganic matrix, especially where the matrix includes acrylic.

According to a preferred embodiment of the present invention, the binding, sizing, and/or coating of the fabric 10 are selected or combined to optimize tensile performance and retention of tensile strength after aging, and to improve compatibility between the fibers, sizing, coating and cementitious matrix. For example, the resinous coating 107 could be a sizing having an adherent coating thereon, in which the added cementitious core 101 is adherent to the added coating. A preferred combination includes a sizing selected from the group consisting of 1) an epoxy polymer, vinyl and amine coupling agents and a non-ionic surfactant; 2) an epoxy polymer, amine coupling agent and a non-ionic surfactant; 3) an epoxy polymer, methacrylic and epoxy coupling agents, and cationic and non-ionic surfactants (paraffin lubricants); 4) anhydrous polymerized acrylate amine, methacrylic and epoxy coupling agents and a non-ionic surfactant; and 5) anhydrous polymerized epoxy amine, vinyl and amine coupling agents, and a non-ionic surfactant, and a polymeric coating selected from the group consisting of acrylic and PVC plastisol.

Typically to increase chemical bonding the woven knit and laid scrim fabrics may be coated by applying organic or inorganic adhesives or polymers, such as epoxies, acrylics, styrene acrylics, or other suitable coatings or bonding materials, before fabric-forming, as in single-end-coated fabrics.

Typically to increase chemical bonding the woven knit and laid scrim fabrics may be coated by applying organic or inorganic adhesives or polymers, such as epoxies, acrylics, styrene acrylics, sodium silicate, or other suitable coatings or bonding materials, after they have been assembled or laid by in-line (normally roller or dip coated) concurrently with formation such as in the case of laid scrim nonwoven meshes.

Typically to increase chemical bonding the woven knit and laid scrim fabrics may be coated by applying organic or inorganic adhesives or polymers, such as epoxies, acrylics, styrene acrylics, sodium silicate, or other suitable coatings or bonding materials, after they have been assembled or laid by off-line coated after formation (normally roller or dip coated), typically used with many woven fabrics.

### Adhering Uncoated Strands (Yarns)

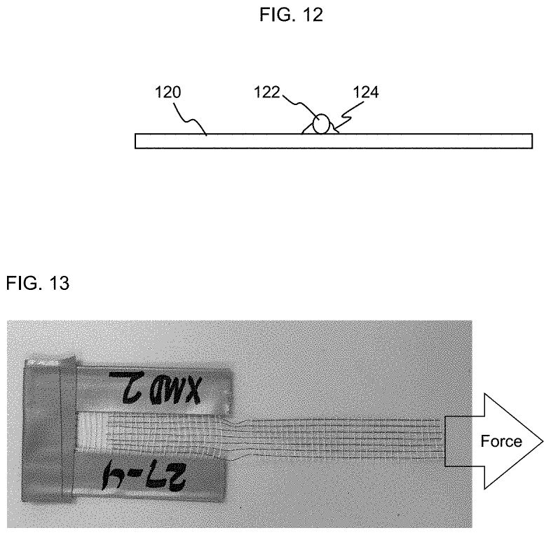

To increase chemical bonding, the woven knit and laid scrim fabrics may be uncoated but modified by adhering the strands of scrim together where machine direction and cross-machine strands intersect, for example with cyanoacrylate glue or applying organic or inorganic adhesives or polymers, such as epoxies, acrylics, styrene acrylics, sodium silicate, or other suitable coatings or bonding materials, or other adhesive. FIG. 12 shows two fibers 120, 122 adhered by adhesive 124.

For example, U.S. Pat. No. 6,391,131 to Newman, incorporated herein by reference, describes a method to bond transverse and longitudinal yarns at their crossover points that may be employed for the present invention. Also for example, the invention can use single end coating or roll coating, similar to how PVC is typically applied to apply the adhesive if the strands are not coated.

The transverse yarns and the longitudinal yarns are bonded at their crossover points to provide dimensional stability to the scrim and therefore to the glass fiber facing sheet. Preferably, the transverse yarns and the longitudinal yarns are bonded at their crossover points by a polymeric binder. The polymeric binder is preferably applied as a low viscosity coating so that it can uniformly penetrate into the transverse yarns and longitudinal yarns and coat the filaments forming the yarns. Numerous different polymeric binders capable of penetrating the transverse yarns and the longitudinal yarns and interlocking the transverse yarns and longitudinal yarns together at their crossover points can be used in the invention. Preferably, the polymeric binder is an alkali and moisture resistant thermoplastic or thermosetting polymer coating which can, in addition to providing dimensional stability to the scrim, also prevent chemical interaction between the cementitious materials forming the core of the cement board and the glass filamentary material, particularly when an alkaline and/or silicious cementitious material, e.g. Portland cement, is contained in the core of the cement board. Exemplary moisture resistant materials for the polymeric binder include cyanoacrylate glue, polyvinyl chloride, polyvinyl acetate, polyvinylidene chloride, polyvinyl alcohol, styrene butadiene rubber, urethane, silicone, metallic resinates, wax, asphalt, acrylic resins, styrene acrylate copolymers, aromatic isocyanates and diisocyanates, organo hydrogen polysiloxanes, thermoset resins such as epoxies and phenolics, mixtures thereof, and the like. The preferred polymeric binder for binding the transverse yarns and the longitudinal yarns is polyvinyl chloride (PVC) which is applied as a plastisol. Preferably, the polymer coating is applied to the scrim in between about 5 and 150 parts dry weight of resin to 100 parts by weight of fabric. In other words, the coating is applied at 5% to 150% dry weight pick-up.

### Altering Mechanical Bonding

To improve the cement board flexural strength, the mechanical bond of the intersecting yarns of the scrim and the corresponding mechanical bond of the resulting scrim to the cementitious matrix may be altered by increasing the overall roughness and/or surface area of the coated yarns and/or the resulting scrim. This may be achieved either by embossing or roughening the surface of the coating, such as the PVC coating, or by utilizing different weaving patterns that increase the intersectional bond strength and surface area of the resulting scrim. To be more specific, embossing could be achieved by using an embossing roller in the scrim manufacturing process prior or post drying the PVC coating. This may also be achieved by bonding of various fillers or fibers such as glass fiber, basalt fiber, alkaline resistant fiber, calcium carbonate, quartz, sand, fly ash, perlite, expanded aggregate or other similar materials into or on the scrim coating, for example PVC scrim coating.

Also, the invention may increase cement board flexural strength with a scrim modified to improve mechanical bonding by increasing the overall the roughness and/or surface area of the scrim using scrim that has an alternate weaving pattern. Additional weaves that increase surface area or add a third dimension such as a pile or velvet weave may improve mechanical bonding.

### Board Manufacturing

With reference to FIG. 9, a preferred method of continuously manufacturing cementitious boards is described.

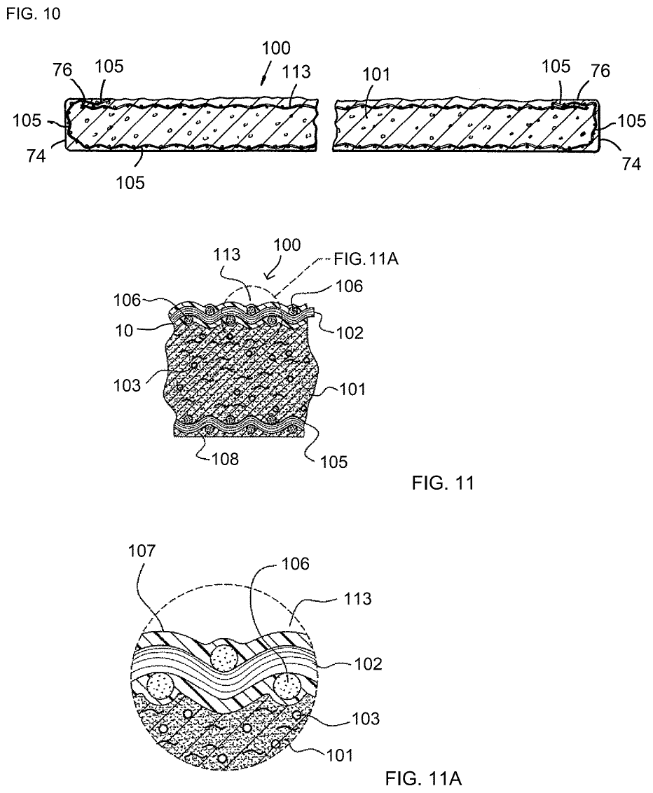

A typical cement panel 100 of the invention is shown in cross-section in FIG. 10 to reveal a core 101 which extends through the bottom mesh 105 even as the mesh bends up and around to overlap the top mesh 113 which lies just beneath the upper surface of the panel. Thus, the cementitious material in the cement panel 100 is an autogenous binder for the lapping meshes 105 and 113 at the margins 76 of the upper surface of the panel. As shown, the edges 74 and the margins 76 are smooth because of the smoothing effect of carrier sheet strips being pressed onto the mix by rails and spatulas of a cement panel production line, as for example shown in U.S. Pat. No. 4,916,004 to Ensminger et al. The smooth margins 76 are preferred when the cement panels are fastened side-by-side on a partition and joint tape is adhesively applied to the margins before joint compound is applied. Although FIG. 10 shows the folded bottom mesh 105 overlying the woven top mesh 113 along the margins, the panel of this invention may be made so that the folded basalt mesh 105 lies under the top mesh 113. Moreover, although the cement panel having the top mesh 113 is described, it will be understood that the top mesh is not essential to this invention. In the invention the scrim is typically embedded between about 0.03 to about 0.06 inches into at least one of the planar surface of the cement core layer 101.

Because of its cementitious nature, a cement panel (board) may have a tendency to be relatively brittle at its edges which often serve as points of attachment for the panels. Thus, optionally the edges 74 may be provided with additional mesh reinforcement (not shown) or an alternate reinforcing material, or a combination thereof. For example, the mesh reinforcement can be wrapped around edges 74. The reinforcement is embedded in the cementitious core 101.

While it is preferred that slightly-modified, conventional wallboard or cement board manufacturing equipment be employed for producing the cementitious boards 100 of this invention, cementitious boards 100 with facings 105 and 113 which contain fabric 10 can be manufactured in any number of ways, including molding, extrusion, and semi-continuous processes employing rollers and segments of the fabric 10 of this invention. As shown in FIG. 11, the fabric 10 can be in the form of a facing 105 which can be embedded in the cementitious core 101, such as to present a thin cementitious film 108 on the face of the board 100. Facing 113 can be embedded, or alternatively, be adhesively or mechanically bonded to the core 101 such as by the set core 101, itself, as shown in FIG. 11. Although FIG. 9 labelled fabric as fabric 10 which is also in FIG. 2, the fabric may be any fabric of the invention.

With further reference to FIG. 11, which is a blown up segment of the coated board shown in FIG. 9, and further blown up segment of FIG. 11A, the detail of a preferred a cementitious board 100 is provided. The cementitious board 100 includes a set cementitious core 101, made of set cement, for example. The cementitious core 101 preferably comprises a cementitious material, such as cement paste, mortar or concrete, and/or other types of materials such as gypsum and geopolymers (inorganic resins). Preferably the fibers are AR-glass fibers but may also include, for example, other types of glass fibers, basalt, aramids, polyolefins, carbon, graphite, polyester, PVA, polypropylene, natural fibers, cellulosic fibers, rayon, straw, paper and hybrids thereof. The inorganic matrix may include other ingredients or additives such as fly ash, latex, slag and metakaolin, resins, such as acrylics, polyvinyl acetate, or the like, ceramics, including silicon oxide, titanium oxide, and silicon nitrite, setting accelerators, water and/or fire resistant additives, such as siloxane, borax, fillers, setting retardants, dispersing agents, dyes and colorants, light stabilizers and heat stabilizers, shrinkage reducing admixtures, air entraining agents, setting accelerators, foaming agents, or combinations thereof, for example. In a preferred embodiment, the inorganic matrix includes a resin that may form an adhesive bond with a resinous coating applied to the alkali-resistant open fibrous layer. Preferably the cementitious core 101 has good bonding with the facings 105 and 113 which contain fabric 10, but also may be composite materials, including additional mats, or scrim of fabrics, for example. The cementitious core 101 may contain curing agents or other additives such as coloring agents, light stabilizers and heat stabilizers, for example.

Examples of optional materials which have been reported as being effective for improving the water-resistant properties of cementitious products either as a binder, finish or added coating, or performance additive 103 are the following: poly(vinyl alcohol), with or without a minor amount of poly(vinyl acetate); metallic resinates; wax or asphalt or mixtures thereof; a mixture of wax and/or asphalt and also corn-flower and potassium permanganate; water insoluble thermoplastic organic materials such as petroleum and natural asphalt, coal tar, and thermoplastic synthetic resins such as poly(vinyl acetate), polyvinylchloride and a copolymer of vinyl acetate and vinyl chloride and acrylic resins; a mixture of metal rosin soap, a water soluble alkaline earth metal salt, and residual fuel oil; a mixture of petroleum wax in the form of an emulsion and either residual fuel oil, pine tar or coal tar; a mixture comprising residual fuel oil and rosin, aromatic isocyanates and diisocyanates; organo hydrogen polysiloxanes and other silicones, acrylics, and a wax-asphalt emulsion with or without such materials as potassium sulfate, alkali and alkaline earth eliminates. Performance additives 103 can be introduced directly into the cementitious slurry 28. The added coating can be applied to the fabric 10 before and/or after joining to the cementitious core 101.

If gypsum is employed, the core may be formed by mixing water with powdered anhydrous calcium sulfate or calcium sulfate hemihydrate (CaSO4 [1/2]H2O), also known as calcined gypsum, and thereafter allowing the mixture to hydrate or set into calcium sulfate dihydrate (CaSO₄·2H₂O), a relatively hard material. The cementitious core 101 of the support member will in general comprise at least about 85 wt. % set gypsum or cement.

The surface of the cementitious core 101 is faced with one or more layers of the fabric 10. The fabric 10 should be at least sufficiently porous to permit water in the aqueous slurry from which the core is made to evaporate therethrough, and may be porous enough to permit the slurry to pass through and form a continuous or discontinuous film 108. As described in the detail below, the cementitious board 100 in the present invention can be made efficiently by forming an aqueous slurry which contains excess water and placing thereon the facing material. Aided by heating, excess water evaporates through the preferred upper and lower glass fabric facings 105 or 22 and 116 or 32 as the cementitious slurry 28 sets.

### Continuous Manufacturing Method

An attractive feature of the present invention is that the cementitious board 100 can be made utilizing existing wallboard or cement board manufacturing lines.

Cementitious boards have been manufactured by casting a hydraulic cement core mixture in the form of a thin, indefinitely long panel. Cementitious boards are generally produced using a core mix of water, light-weight aggregate (e.g., expanded clay, expanded slag, expanded shale, perlite, expanded glass beads, polystyrene beads, and the like) and a cementitious material (e.g., Portland cement, magnesia cement, alumina cement, gypsum and blends of such materials). A foaming agent as well as other additives can be added to the mix. The hydraulic cement core mix is usually a mortar containing a mixture of water and Portland cement, sand, mineral or non-mineral aggregate, fly ash, accelerators, plasticizers, foaming agents and/or other additives. A strippable paper (carrier sheet) is deposited on a forming table, then a scrim fed from a roll is deposited on the strippable paper, then a continuous stream of mortar slurry is deposited onto the scrim. The mortar is then distributed across the breadth of the carrier sheet, and the mortar-laden carrier sheet is towed through a slit defined by a supporting surface and a cylindrical mortar screeding roller mounted above the supporting surface so that its axis is transversely parallel to the supporting surface. The long network of reinforcing fibers is drawn against the roller and through the slit, rotating the roller counter to the direction of the travel of the carrier sheet, whereby the roller presses the network into the surface of the mortar and wipes mortar adhering to the roller into the interstices of the network. The network then tows the resulting broad, flat ribbon of mortar towards a cutter.

In the alternative, for example, as shown somewhat diagrammatically in FIG. 9. In conventional fashion, dry ingredients (not shown) from which the cementitious core 101 (FIG. 10) is formed are pre-mixed and then fed to a mixer of the type commonly referred to as a mixer 30. Water and other liquid constituents (not shown) used in making the core are metered into the mixer 30 where they are combined with the dry ingredients to form an aqueous cementitious slurry 28. Foam is generally added to the cementitious slurry in the mixer 30 to control the density of the resulting cementitious core 101.

The cementitious slurry so produced is then continuously metered and deposited over a continuously moving surface, The said continuously moving surface comprises a glass fabric 22 resting at the bottom and moving at the same speed as the moving surface. The two opposite edge portions of the bottom glass fabric 22 or 105 are progressively flexed upwardly from the mean plane of the bottom glass fabric 22 or 105 and then turned inwardly at the margins so as to provide coverings for the edges of the resulting board 100.

A sheet of top glass fabric 32 or 116 is fed from the top glass fabric roll 29 onto the top of the cementitious slurry 28, thereby sandwiching the slurry between the two moving fabrics which form the facings of the cementitious core 101 which is formed from the cementitious slurry 28. The bottom and top glass fabrics 22 (or 105) and 32 (or 116), with the cementitious slurry 28 sandwiched there between enter the nip between the upper and lower forming or shaping rolls 34 and 36 and are thereafter received on a conveyer belt 38. Conventional edge guiding devices 40 shape and maintain the edges of the composite until the slurry has set sufficiently to retain its shape. Water of convenience, or excess water, can optionally be drained with the assistance of vacuum boxes 42 disposed below the conveyor belt 38. In due course, sequential lengths of the board are cut by a knife, saw, or any other suitable cutting device 44. The cementitious board 100 is next moved along feeder rolls 46 to permit it to set. It is optionally processed by exposure to heat in a drying oven 48 which accelerates the drying of the board by increasing the rate of evaporation of excess water. An additional sprayer 49 can be provided to add further treatments, such as silicone oil, additional coating, or fire retardants, to the board's exterior. The manufacturing techniques described in the “Background” section are also acceptable.

The fabric 10 and cementitious boards 100 of this invention are useful in all sorts of building construction applications. They are strong, having a screw strength of at least about 20 lbs., for gypsum cores of conventional densities and compositions. Some examples include shaft wall assemblies for elevators and stairways, fire doors and fire walls, roofing and siding substrates, with or without insulation, and tile backer boards. Some of the most desirable and useful applications for this invention are in EIF systems (also called EIFS, for Exterior Insulation Finishing Systems), or as tile backer boards.

From the foregoing, it can be realized that this invention provides improved coatings and coating techniques for fabrics and reinforcements, and, for example, may enable not only a more uniform coating to be applied to the warp and weft yarns of a knitted, braided, nonwoven mesh-type, or woven fabric but also increased intersectional bond strength between the warp and the weft yarns of the said fabrics. More uniform coatings enable composites, especially those containing cementitious cores, to last longer, achieve better aesthetics, strength and corrosion resistance. The more uniform coatings applied to the reinforcements of this invention can achieve better uniform bonding between glass facings and cement or gypsum cores of boards, as well as better surface finish in cement boards. When alkali-resistant coatings are used, the more uniform weight distribution of the disclosed coatings permits the boards to achieve greater service life. This can be extended to matrices which must be resistant to fire, rain water and/or salt air. A more uniform coating can also assist the disclosed reinforcements to bond more adherently to a polymer or cementitious matrix and to other yarns having a similar coating in the fabric, as well as assist in bonding to externally applied adhesives, mortars, or the like. Enhanced intersectional bond strength between the warp and the weft yarns of the fabric increases the fabric reinforcing efficiency in a cementitious composite.

### Clauses of the Invention

The following clauses describe various features of the invention.

Clause 1. A fabric reinforcement for reinforcing an alkaline cementitious matrix, preferably for improving flexural strength of a cement board made with the alkaline cementitious matrix reinforced with the fabric reinforcement, comprising a plurality of warp yarns and a plurality of weft yarns;

(a) wherein to increase the cohesive/tensile strength of the intersection points of the fabric reinforcement, preferably such that the fabric reinforcement has cohesive tensile strength of about 0.15 to 0.60 pounds force per bonded intersection point of the fabric reinforcement, preferably such that the fabric's intrinsic tensile strength is realized, the fabric has:
(1) a resinous coating disposed over a substantial portion of said warp and weft yarns, before said fabric reinforcement is embedded within, or adhesively or mechanically bonded to said alkaline cementitious matrix, the coating comprises organic or inorganic adhesives/polymers, such as polyvinyl chloride (PVC), epoxies, acrylics, styrene acrylics, cyanoacrylate, or sodium silicate, wherein preferably the coating comprises PVC fiber coating of increased weight, and/or the coating has a PVC coating with increased stiffness/strength, or
(2) an uncoated scrim modified by adhering the warp yarns and weft yarns together at intersections where warp yarns and weft yarns intersect, for example with organic or inorganic adhesives or polymers, such as cyanoacrylate glue, epoxies, acrylics, styrene acrylics, other suitable bonding materials, or other adhesives; and/or
   (b) wherein effective to alter mechanical bonding of the fabric reinforcement to the alkaline cementitious matrix, the fabric reinforcement has increased overall roughness and/or surface area relative to a fabric reinforcement having a scrim having respectively relatively lesser overall roughness and/or surface area, preferably such that the fabric reinforcement has overall roughness Ra of about 0.1 microns to about 1.5 microns.

Clause 2. The fabric reinforcement of clause 1,

wherein said resinous coating is in a sufficient amount effective to increase the cohesive tensile strength of the intersection points of the fabric, for example by at least 10%, preferably at least 30%, more preferably at least 50%, most preferably at least 100%, compared to fiberglass scrims coated with PVC coatings, wherein fiberglass yarns of the fiberglass scrims coated with PVC coatings typically comprise G75 and/or G37 yarns, and the PVC coating weight ranges between 45-65 wt % of the total weight of the scrim; and/or

wherein said adhering of the warp yarns and weft yarns together at intersections is effective to increase the cohesive tensile strength of the fabric, for example by at least 10%, compared to fabric of the same yarn, warp and weft lacking said adhering at the intersections, preferably such that the fabric's intrinsic tensile strength is realized; and/or

wherein the fabric reinforcement has 10% increased overall roughness and/or surface area relative to the fabric reinforcement having the scrim having respectively relatively lesser overall roughness and/or surface area; and/or

wherein the fabric reinforcement has overall roughness Ra of about 0.1 microns to about 1.5 microns, and/or the fabric has a surface area of about 1.20 to 2.0 square inch per square inch planar area of fabric.

Clause 3. The fabric reinforcement of clause 1, wherein the fabric reinforcement has cohesive tensile strength of about 0.15 to 0.60 pounds force per bonded intersection point of the fabric reinforcement.

Clause 4. The fabric reinforcement of clause 1, wherein the fiber resinous coating comprises the PVC coating of increased weight and/or the PVC coating has increased stiffness and/or strength, wherein said PVC coating preferably has a Gurley stiffness of greater than 130 mg/in per ASTM D5732.

Clause 5. The fabric reinforcement of clause 1, wherein said organic or inorganic adhesives/polymers are selected from polyvinyl chloride (PVC), epoxies, acrylics, styrene acrylics, or sodium silicate, polyvinyl acetate, polyvinyl alcohol, ethylene vinyl acetate co-polymer, vinyl chlorides, vinyl acrylic co-polymer, styrene acrylics, styrene butadiene, polyacrylamide, polyvinyl acrylic, or latex emulsions.

Clause 6. The fabric reinforcement of clause 1, wherein said warp yarns, said weft yarns, or both, comprise glass fibers and/or basalt fibers.

Clause 7. The fabric reinforcement of clause 1 wherein said warp yarn and weft yarns are assembled into one or more of: a woven fabric, knit fabric, laid scrim fabric, or braided fabric.

Clause 8. The fabric reinforcement of clause 1, the fabric is coated by applying organic or inorganic adhesives or polymers, such as epoxies, acrylics, styrene acrylics, or other suitable coatings or bonding materials, before fabric-forming, typically by coating the yarns, as in single-end-coated fabrics.

Clause 9. The fabric reinforcement of clause 1, the fabric may be coated by applying organic or inorganic adhesives or polymers, such as epoxies, acrylics, styrene acrylics, sodium silicate, or other suitable coatings or bonding materials, after they have been assembled or laid by in-line coating (normally roller or dip coated) concurrently with formation such as in the case of laid scrim nonwoven meshes.

Clause 10. The fabric reinforcement of clause 1, the fabric may be coated by applying organic or inorganic adhesives or polymers, such as epoxies, acrylics, styrene acrylics, or other suitable coatings or bonding materials, after they have been assembled or laid by off-line coating after formation (normally roller or dip coated), typically used with woven fabrics.

Clause 11. The fabric reinforcement of clause 1, the fabric may be uncoated but modified by adhering the warp yarns and weft yarns together where the warp yarns and weft yarns intersect, for example by applying organic or inorganic adhesives or polymers, such as cyanoacrylate glue, epoxies, acrylics, styrene acrylics, or other suitable coatings or bonding materials, or other adhesives.

Clause 12. The fabric reinforcement of clause 1, wherein the fabric reinforcement comprises glass fiber fabric, wherein the coating comprises an alkali resistant coating on the glass fiber fabric that is selected from the group of polyvinyl chloride, polyvinyl alcohol, polyvinyl acetate, polyester, acrylics, acrylonitrile, silicones, styrene-butadiene, polypropylene, epoxy and polyethylene, and mixtures thereof, preferably in an amount from 10 to 70% of the total weight of the coated fiberglass fabric, more preferably in an amount from 20 to 50% of the weight of the coated glass fiber fabric.

Clause 13. The fabric reinforcement of clause 1, wherein said fabric is a multifilament yarn-based woven, braided, nonwoven mesh-type, or knitted fabric.

Clause 14. The fabric reinforcement of clause 1, wherein the fabric reinforcement is a fiberglass fabric reinforcement having between 2×2 and 8×8 strands per inch construction in both the lateral and transverse directions.

Clause 15. The fabric reinforcement of clause 1, wherein the fabric reinforcement is a fiberglass fabric reinforcement having a 8×4, 2×2, 6×6, 6×4, 2×3, or 4.0×4.0 strands per inch construction in both the lateral and transverse directions.

Clause 16. The fabric reinforcement of clause 1,

wherein the fabric reinforcement is a fiberglass fabric reinforcement having about 3×3 to 6×8 strand per inch construction in the longitudinal and transverse direction, respectively, and

wherein the fiberglass fabric reinforcement is made from a coated fiberglass yarn, the yarn in an uncoated state has a nominal density of about 1200 to 10,000 linear yards per pound of fiberglass yarn, for example 1200 to 7000 or 5000 to 8000 linear yards per pound of fiberglass yarn.

Clause 17. The fabric reinforcement of clause 1, wherein the fabric comprises 20 to 80, typically 40 to 80 or 40 to 65, wt. % resinous coating on a dry basis.

Clause 18. The fabric reinforcement of clause 1, wherein the fabric reinforcement has between about 3×3 to about 6×8 strand of fiberglass fiber per inch of the mesh construction in both the longitudinal and transverse directions, respectively, and the fiberglass mesh is made from a coated fiberglass yarn, the yarn in an uncoated state has a nominal density of about 1200 to 8000, for example 3700 to 8000, linear yards per pound of the fiberglass yarn; and

the coated yarn comprises 20-80 wt. % coating on a dry basis;

the coating comprises alkali resistant polymer.

Clause 19. A method of reinforcing a cementitious board, comprising providing a core layer of cementitious material, the core layer having opposed planar surfaces and opposed edges, and at least one outer layer of fabric reinforcement embedded within the opposed planar surfaces, comprising:

applying the fabric reinforcement of any of clauses 1-18 to the upper and lower surfaces of a core cementitious slurry by pouring the cementitious slurry through the fabric reinforcement to coat and to embed the entire fabric reinforcement in the cementitious slurry before the slurry is set;

wherein the cementitious material comprises:

25 to 60 wt. %, on a wet basis, cementitious reactive powder comprising hydraulic cement, for example Portland cement,

10 to 40 wt. % water,

1 to 70 wt. %, on a wet basis, of filler; and

optional additive selected from at least one member of the group consisting of water reducing agents, chemical set-accelerators, chemical set-retarders, air-entraining agents, foaming agents, shrinkage control agents, coloring agents, viscosity modifying agents and thickeners, and internal curing agents.

Clause 20. A cementitious board incorporating the fabric reinforcement of any of clauses 1-18.

Clause 21. The cementitious board of clause 20, comprising: a core layer of cementitious material having opposed planar surfaces and opposed edges;

at least one outer layer of the fabric reinforcement embedded in the opposed planar surfaces of the core layer;

wherein the cementitious material comprises:

25 to 60 wt. %, on a wet basis, cementitious reactive powder comprising hydraulic cement, for example comprising Portland cement,

10 to 40 wt. % water,

1 to 70 wt. %, on a wet basis, of filler;

optional additive selected from at least one member of the group consisting of water reducing agents, chemical set-accelerators, chemical set-retarders, air-entraining agents, foaming agents, shrinkage control agents, coloring agents, viscosity modifying agents and thickeners, and internal curing agent.

Clause 22. The cementitious board of clause 20, wherein the filler is perlite filler, a lightweight aggregate or fillers selected from the group consisting of blast furnace slag, volcanic tuff, pumice, sand, expanded clay, expanded shale, expanded perlite, hollow ceramic spheres, hollow plastic spheres, expanded plastic beads, and mixtures thereof.

Clause 23. The cementitious board of clause 20, wherein the fabric reinforcement is embedded between about 0.03 to about 0.06 inches into at least one of the planar surface of the cement core layer.

Clause 24. The cementitious board of clause 20, wherein the density of the cement board is about 30 to 100 pounds per cubic foot, typically about 40 to 100 pounds per cubic foot.

Clause 25. The cementitious board of clause 20, wherein the density of the cement board is about 40 to 100 pounds per cubic foot, typically about 50 to 80 pounds per cubic foot.

### EXAMPLES

### Example 1

Two standard e-glass scrims with PVC coating commonly used in cement boards were selected for the following set of experiments. Typical e-glass fibers used are G75 and G37 which have a lineal weight of approximately 68 and 136 tex, respectively. The first scrim, referred to and an 8×8, consists of eight G75 yarns per inch in the machine direction and eight G75 yarns per inch in the cross-machine direction respective to the weaving machine. A second scrim, referred to as an 8×4, consists of eight G75 yarns per inch in the machine direction and four G37 yarns per inch in the cross-machine direction respective to the weaving machine. It is noted that the overall weight of glass fiber is approximately the same in both scrims. A third scrim was prepared using the same 8×4 scrim with cyanoacrylate adhesive was individually applied to each intersection where a cross machine yarn crossed a machine yarn.

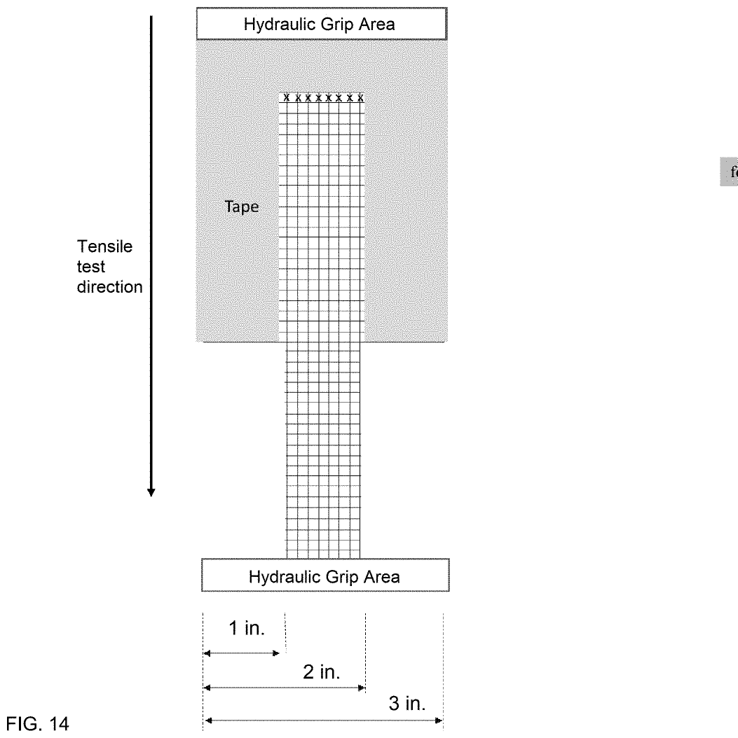

To test and measure the tensile strength of the coating, samples were prepared and tested with a test device according to the photograph of FIG. 13 and the drawing of FIG. 14. In FIG. 14 the individual lines denote a single yarn, the light gray boxes denote a heavy adhesive tape applied around the scrim, the dark gray boxes denote the area where samples were gripped for tensile testing. Individual yarns in the test direction were cut as denoted by individual x's. The hydraulic grip areas are then pulled apart while the pounds-force of this pulling apart is measured. The pounds-force at the point of breakage (fracture) is the cohesive tensile strength. By clipping the individual yarns, the test is understood to measure the cohesive tensile strength of the intersections with no contribution from glass fiber. Note that slight variations in the dimensions of the test area may be considered to alter the number of yarn intersections being tested. Additionally, samples can be tested in multiple configurations including machine and cross machine direction.

The cohesive tensile strength of the three scrims that were tested is shown in the TABLE 18. Intersection cohesive tensile strength is the overall cohesive tensile strength of the fabric. In contrast, Cohesive tensile strength per bonded intersection point is the overall cohesive tensile strength of the fabric divided by the number of bonded intersection points. For example, the 8×4 scrim for samples listed in TABLE 18 had 96 intersection points. Thus, for the 8×4 scrim (Scrim 2) the Cohesive tensile strength per bonded intersection point of about 0.116 lbf is the Intersection cohesive tensile strength of 11.1 lbf divided by 96. The testing showed that an 8×8 scrim has 6.2 lbf (56%) higher max load when compared to an 8×4 scrim. This is expected since the 3×1 in. test area for an 8×8 scrim would have approximately 192 yarn intersection points and an 8×4 scrim would have approximately 96 intersections, or 50% less intersections. Surprisingly, when the cyanoacrylate adhesive was applied to the 8×4 scrim intersections it resulted in a 20.7 lbf (186%) increase in max load when compared to a standard 8×4 scrim. Additionally, it resulted in 14.5 lbf (84%) increase in max load when compared to an 8×8 scrim, which has double the intersection points. TABLE 18 also shows cohesive tensile strength per bonded intersection point of the scrim. It can be observed that for the regular 8×4 scrim (Scrim 2), the cohesive tensile strength was only 0.116 lbf/bonded intersection point, while the same for the 8×4 scrim of this invention (Scrim 3), the cohesive tensile strength increased substantially to 0.331 lbf/bonded intersection point.

Standard scrim reinforced cementitious lab panels were made with formulations similar to Published U.S. Patent Application number US2012/0148806A1 with a density of 75 pcf. The flexural strength of the samples was tested and shown in the Table 18. The testing showed that a cementitious panel with an 8×8 scrim has 303 psi (39%) higher flexural strength and 0.36 in. (49%) higher maximum deflection than a panel prepared with an 8×4 scrim. Surprisingly, when a panel was prepared with an 8×4 scrim with cyanoacrylate adhesive, it resulted substantially similar flexural strength and max deflection as the panel prepared with an 8×8 scrim.

TABLE 18

| | Scrim Testing | | | |
|---|---|---|---|---|
| | | Cohesive | Cementitious | |
| | Intersection | tensile strength | Panel Testing | |
| | cohesive | per bonded | Flexural | Peak |
| | tensile strength | intersection | Strength | Deflection |
| Variant | (lbf) | point (lbf) | (psi) | (in.) |
| Scrim 1- 8 × 8 | 17.3 | 0.090 | 1079 | 1.09 |
| Scrim 2- 8 × 4 | 11.1 | 0.116 | 776 | 0.73 |
| Scrim 3- 8 × 4 + | 31.8 | 0.331 | 1048 | 1.11 |
| cyanoacrylate | | | | |
| adhesive | | | | |

### Example 2

The following scrims were prepared with an 8×4 scrim from Example 1 (Scrim 2). A scrim (Scrim 4) was prepared by brushing approximately 0.01 lb/ft2 of RHOPLEX AC 1034 (water-based styrene acrylic polymer emulsion) on the scrim on both sides and allowed to air dry. A second scrim (Scrim 5) was prepared by brushing approximately 0.01 lb/ft2 of RHOPLEX AC 1034) over the scrim and while the polymer was still wet was dipped into a tray of coarse sand (W540, Black Lab Corp, Serena, Ill.) adhering approximately 0.06 lb/ft2 into the polymer material and the composite was allowed to air dry. A third scrim (Scrim 6) was prepared by brushing approximately 0.01 lb/ft2 of RHOPLEX AC 1034 over the scrim and while the polymer was still wet was dipped into a tray of fine perlite (35-23, Silbrico Corporation, Hodgkins, Ill.) adhering approximately 0.001 lb/ft2 into the polymer material and the composite was allowed to air dry. A fourth scrim (Scrim 7) was prepared by brushing approximately 0.01 lb/ft2 of RHOPLEX AC 1034) over the scrim and while the polymer was still wet was dipped into a tray of 3 mm alkali resistant chopped glass fibers (CEM-FIL 70, Owens Corning, Toledo, OH) adhering approximately 0.05 lb/ft2 into the polymer material and the composite was allowed to air dry.

Standard scrim reinforced cementitious lab panels with the same formulation were prepared with a density of approximately 58 pcf. An additional panel using a 4×4 scrim (Scrim 8) consisting of four G37 yarns per inch in the machine direction and four G37 yarns per inch in the cross-machine direction respective to the weaving machine. An additional non-woven glass mat with a density of approximately 0.002 lb/ft2 (RR201, Unzin, Germany) was laid on the outside surface of the scrim. The flexural strength of the samples was tested and shown in the TABLE 19.

TABLE 19

| | Cementitious Panel Testing | |
|---|---|---|
| | Flexural | Peak |
| | Strength | Deflection |
| Variant | (psi) | (in.) |
| Scrim 2- 8 × 4 | 647 | 0.93 |
| Scrim 4- 8 × 4 + polymer | 692 | 1.04 |
| Scrim 5- 8 × 4 + polymer + sand | 732 | 1.2 |
| Scrim 6- 8 × 4 + polymer + perlite | 860 | 1.32 |
| Scrim 7- 8 × 4 + polymer + chopped fiber | 913 | 0.8 |
| Scrim 8- 4 × 4 + non-woven glass mat | 713 | 0.29 |

While not being bound by theory, it is expected increasing the cohesive tensile strength of the intersection points will result in higher flexural strength and max deflection. The inventors theorize this can be achieved through many possible routes including but not limited to, applying organic or inorganic adhesives/polymers, such as epoxies, acrylics, styrene acrylics, or sodium silicate, increasing PVC fiber coating weight, increasing strength of the PVC coating, or using alternate weaving patterns.

In the examples herein, as mentioned above, percentages of compositions or product formulae are in weight percentages, unless otherwise expressly stated. The reported measurements also in approximate amounts unless expressly stated, for example, approximate percentages, weights, temperatures, distances or other properties.

In the present specification all percentages, ratios and proportions herein are by weight, unless otherwise specified. In the present specification a dry basis means a water free basis. In the present specification a wet basis means a water inclusive basis. Water inclusive basis means water and the other ingredients basis.

The claims form part of the disclosure and are incorporated by reference into the present specification.

While particular versions of the invention have been shown and described, it will be appreciated by those skilled in the art that changes and modifications may be made thereto without departing from the invention in its broader aspects and as set forth in the following claims.

1. A fabric reinforcement for reinforcing an alkaline cementitious matrix, comprising a plurality of warp yarns and a plurality of weft yarns;
(a) wherein to increase the cohesive/tensile strength of the intersection points of the fabric reinforcement the fabric has:
(1) a resinous coating disposed over a substantial portion of said warp and weft yarns, before said fabric reinforcement is embedded within, or adhesively or mechanically bonded to said alkaline cementitious matrix, the coating comprises organic or inorganic adhesives/polymers, or
(2) an uncoated scrim modified by adhering the warp yarns and weft yarns together at intersections where warp yarns and weft yarns intersect; and/or
(b) wherein effective to alter mechanical bonding of the fabric reinforcement to the alkaline cementitious matrix, the fabric reinforcement has increased overall roughness and/or surface area relative to a fabric reinforcement having a scrim having respectively relatively lesser overall roughness and/or surface area.

2. The fabric reinforcement of claim 1,
wherein said resinous coating is in a sufficient amount effective to increase the cohesive tensile strength of the intersection points of the fabric; and/or
wherein said adhering of the warp yarns and weft yarns together at intersections is effective to increase the cohesive tensile strength of the fabric compared to fabric of the same yarn, warp and weft lacking said adhering at the intersections; and/or
wherein the fabric reinforcement has 10% increased overall roughness and/or surface area relative to the fabric reinforcement having the scrim having respectively relatively lesser overall roughness and/or surface area; and/or
wherein the fabric reinforcement has overall roughness Ra of about 0.1 microns to about 1.5 microns, and/or the fabric has a surface area of about 1.20 to 2.0 square inch per square inch planar area of fabric.

3. The fabric reinforcement of claim 1, wherein the fabric reinforcement has cohesive tensile strength of about 0.15 to 0.60 pounds force per bonded intersection point of the fabric reinforcement.

4. The fabric reinforcement of claim 1, wherein the fiber resinous coating comprises the PVC coating of increased weight and/or the PVC coating has increased stiffness and/or strength.

5. The fabric reinforcement of claim 1, wherein said organic or inorganic adhesives/polymers are selected from polyvinyl chloride (PVC), epoxies, acrylics, styrene acrylics, or sodium silicate, polyvinyl acetate, polyvinyl alcohol, ethylene vinyl acetate co-polymer, vinyl chlorides, vinyl acrylic co-polymer, styrene acrylics, styrene butadiene, polyacrylamide, polyvinyl acrylic, or latex emulsions.

6. The fabric reinforcement of claim 1, wherein said warp yarns, said weft yarns, or both, comprise glass fibers and/or basalt fibers.

7. The fabric reinforcement of claim 1 wherein said warp yarn and weft yarns are assembled into one or more of: a woven fabric, knit fabric, laid scrim fabric, or braided fabric.

8. The fabric reinforcement of claim 1, the fabric is coated by applying organic or inorganic adhesives or polymers.

9. The fabric reinforcement of claim 1, the fabric is coated by applying organic or inorganic adhesives or polymers after they have been assembled or laid by in-line coating concurrently with formation.

10. The fabric reinforcement of claim 1, the fabric is coated by applying organic or inorganic adhesives or polymers after they have been assembled or laid by off-line coating after formation.

11. The fabric reinforcement of claim 1, the fabric may be uncoated but modified by adhering the warp yarns and weft yarns together where the warp yarns and weft yarns intersect by applying organic or inorganic adhesives or polymers.

12. The fabric reinforcement of claim 1, wherein the fabric reinforcement comprises glass fiber fabric, wherein the coating comprises an alkali resistant coating on the glass fiber fabric that is selected from the group of polyvinyl chloride, polyvinyl alcohol, polyvinyl acetate, polyester, acrylics, acrylonitrile, silicones, styrene-butadiene, polypropylene, epoxy and polyethylene, and mixtures thereof.

13. The fabric reinforcement of claim 1, wherein said fabric is a multifilament yarn-based woven, braided, nonwoven mesh-type, or knitted fabric.

14. The fabric reinforcement of claim 1, wherein the fabric reinforcement is a fiberglass fabric reinforcement having between 2×2 and 8×8 strands per inch construction in both the lateral and transverse directions.

15. The fabric reinforcement of claim 1, wherein the fabric reinforcement is a fiberglass fabric reinforcement having a 8×4, 2×2, 6×6, 6×4, 2×3, or 4.0×4.0 strands per inch construction in both the lateral and transverse directions.

16. The fabric reinforcement of claim 1,
wherein the fabric reinforcement is a fiberglass fabric reinforcement having about 3×3 to 6×8 strand per inch construction in the longitudinal and transverse direction, respectively, and
wherein the fiberglass fabric reinforcement is made from a coated fiberglass yarn, the yarn in an uncoated state has a nominal density of about 1200 to 10,000 linear yards per pound of fiberglass yarn.

17. The fabric reinforcement of claim 1, wherein the fabric comprises 20 to 80 wt. % resinous coating on a dry basis.

18. The fabric reinforcement of claim 1, wherein the fabric reinforcement has between about 3×3 to about 6×8 strand of fiberglass fiber per inch of the mesh construction in both the longitudinal and transverse directions, respectively, and the fiberglass mesh is made from a coated fiberglass yarn, the yarn in an uncoated state has a nominal density of about 1200 to 8000 linear yards per pound of the fiberglass yarn; and
the coated yarn comprises 20-80 wt. % coating on a dry basis;
the coating comprises alkali resistant polymer.

19. A method of reinforcing a cementitious board, comprising providing a core layer of cementitious material, the core layer having opposed planar surfaces and opposed edges, and at least one outer layer of fabric reinforcement embedded within the opposed planar surfaces, comprising:
applying the fabric reinforcement of claim 1 to the upper and lower surfaces of a core cementitious slurry by pouring the cementitious slurry through the fabric reinforcement to coat and to embed the entire fabric reinforcement in the cementitious slurry before the slurry is set;
wherein the cementitious material comprises:
25 to 60 wt. %, on a wet basis, cementitious reactive powder comprising hydraulic cement,
10 to 40 wt. % water,
1 to 70 wt. %, on a wet basis, of filler; and
optional additive selected from at least one member of the group consisting of water reducing agents, chemical set-accelerators, chemical set-retarders, air-entraining agents, foaming agents, shrinkage control agents, coloring agents, viscosity modifying agents and thickeners, and internal curing agents.

20. A cementitious board incorporating the fabric reinforcement of claim 1.

21.-25. (canceled)
